(19) United States
(12) Patent Application Publication
(10) Pub. No.: US 2010/0003426 A1
(43) Pub. Date: Jan. 7, 2010

(54) Optical Film, Manufacturing Method Thereof, Polarizing Plate Employing it and Liquid Crystal Display Device

(76) Inventor: Takatugu Suzuki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/309,785

(22) PCT Filed: Jul. 9, 2007
(86) PCT No.: PCT/JP2007/063660

§ 371 Date: Jan. 29, 2009

(30) Foreign Application Priority Data
Aug. 4, 2006 (JP) 2006-213008

(51) Int. Cl. G02F 1/1335; G02B 1/08; C08F 24/00

(52) U.S. Cl. 428/1.31; 359/485; 526/268; 526/238.21; 264/2.7

(57) ABSTRACT

Disclosed is an optical film having good haze properties, wherein bleedout hardly occurs and deformation problems of the raw material film such as horseback defects and projection defects do not occur even when the film is stored for a long time. Also disclosed are a method for producing such an optical film, a polarizing plate using the optical film, and a liquid crystal display using the polarizing plate. Specifically disclosed is an optical film characterized by containing at least one polymer compound derived from a compound represented by the following general formula (1). [chemical formula 1] (1) (In the formula, R₁-R₆ independently represent a hydrogen atom or a substituent, and R₁ and R₂ may combine together to form a substituent bound by a double bond. In this connection, at least one of R₁-R₆ represents a group having a polymerizable group as a partial structure.)

### FIELD OF THE INVENTION

The present invention relates to a film for a display, a polarizing plate and a manufacturing method thereof, and a liquid crystal display.

### BACKGROUND OF THE INVENTION

A thinner display such as liquid crystal display device, a plasma display and an organic EL display are markedly rising in place of CRT display recently. Much amount of an optical film is used in these displays of new generation. Demand for improvement of various functional characteristics required to the optical film becomes severe year by year because of the thinner type. Accordingly an optical film having improved characteristics is desired.

In recent years development of a thinner and lighter-weighted note type personal computer having a larger image frame and a higher definition is in progress. Accordingly, a protective film for varieties of displays, specifically, a protective film for a liquid crystal display is also more and more intensively required to be thinner and wider, and to have higher quality. Various kinds of resins are used as an optical film for a liquid crystal display. Cellulose ester, polycarbonate and polyolefin are utilized in polarizing plate protective film as the optical film, and most amount of cellulose ester film is overwhelmingly used among them.

Heretofore, this cellulose ester film has been primarily manufactured by a solution casting method. In a solution casting method, cellulose ester dissolved in a solvent is cast on a support to form a film, followed by evaporating the solvent to dry the film, and thus a film is obtained. A liquid crystal display exhibiting a high image quality without unevenness can be obtained by using the film obtained by a solution casting method since it has excellent flatness.

However, a solution casting method requires a large amount of an organic solvent, which has been a problem in view of the large environmental load. Since cellulose ester film is cast by use of a halogen-containing solvent because of the excellent solubility characteristics, decrease of the using amount of a solvent is particularly required. Accordingly, it has become difficult to produce a larger amount of cellulose ester film by a solution casting method.

Further, since it is necessary to remove a solvent remaining in the film inside, facility investment to the manufacturing line such as a drying line, a drying energy and apparatuses for recover and regeneration of an evaporated solvent; and a manufacturing cost have been enormous, and reduction thereof is also an important subject.

On the other hand, disclosed has been a technology to improve spectral characteristics and mechanical characteristics of the cellulose ester film by adding a hindered phenol antioxidant, a hindered amine photo-stabilizer or an acid scavenger at a certain addition ratio (for example, refer to Patent Document 1). Further, as a technology to prevent degradation of an organic material, a variety of stabilizers and a stabilizer composition containing a phosphate ester have been disclosed (for example, refer to Patent Documents 2 and 3). However these stabilizers have various problems such that they are liable to bleed out, are liable to precipitate on a film, haze becomes higher and transparency is degraded because of its low solubility, further that they evaporated during the thermal processing whereby added amount is decreased, stabilizing effect is lowered and manufacturing processor is stained.

A cellulose ester film for an optical use has problems of a production load and a facility load due to solvent used in the manufacturing as well as not fully sufficient optical property and mechanical property, in any case.

In recent years, an attempt has been made to melt cast a cellulose ester film for the application in silver salt photography or in polarizing plate protective film, however, since cellulose ester is a high molecular compound which exhibits a rather high viscosity of the melt, and a high glass transition temperature, it has been known that the leveling of the film is difficult when cellulose ester is melt and extruded through a dies to cast on a cooling drum or on a cooling belt to form a film and that the optical property and the mechanical property of thus obtained film is inferior to those of a solution cast film (for example, refer to Patent Documents 4 and 5).

It has been proved that, when a melt cast film is stored for a long period in a state of being wound on a core, there is a problem that it is liable to generate horseback defects, and defects called as a core set at a core part of a master roll and wrinkles in the film at the start of winding of a film master roll.

A horseback defect is a defect in which film master roll deforms in a U-shape like a horseback to generate belt-form convex parts at approximately 2-3 cm pitches in the vicinity of the central portion, and the surface looks distorted when film is made into a polarizing plate because the deformation remains on film. Heretofore, generation of a horseback defect has been restrained by decreasing a dynamic friction coefficient between bases or by adjusting a height of a knurling treatment provided on the both sides.

Further, a core set is a film deformation defect generated by roughness of a core and a film.

These defects have not been significant problems in the film prepared by a conventional solution casting method, however, it has been found that these defects become significant problems due to the poor flatness of the melt cast film.

Particularly, in recent years, a film master roll is desired to have a wider width and a longer length of film in accordance with the popularization of a larger image screen. Therefore, there is a tendency that the width of a film master roll becomes wider and the weight of a film master roll becomes heavier, and this situation easily causes the above defects. Accordingly, an improvement is strongly desired.

Patent Document 1 JP-A No. 2003-192920

Patent Document 2 JP-B No. S63-26771

Patent Document 3 JP-A No. H11-222493

Patent Document 4 JP-A No. H06-501040

Patent Document 5 JP-A No. 2000-352620

### DISCLOSURE OF THE INVENTION

### Problem to be Dissolved by the Invention

This invention is made in view of the problems described above, and an object of the present invention is to provide an optical film which has good haze, causes no deformation defects of a film master roll such as a horseback defect or a convex defect even after a long term storage, manufacturing method of the optical film, a polarizing plate employing it, and a liquid crystal display utilizing the polarizing plate.

### Technical Means to Dissolve the Problem

The above-described problem is dissolved by followings.

1. An optical film containing at least one of high molecular compound derived from a compound represented by Formula (1).

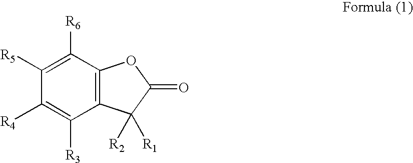

In the formula, R₁-R₆ are a hydrogen atom or a substituent, R₁ and R₂ may be a substituent bonded via double bond together, provided that at least one of groups represented by R₁-R₆ is a group having a polymerizable group as a partial structure. The substituent is an alkyl group, a cycloalkyl group, an aryl group, an acylamino group, an alkylthio group, an arylthio group, an alkenyl group, a halogen atom, an alkynyl group, a heterocyclic group, an alkylsulfonyl group (such as a methylsulfonyl group and an ethylsulfonyl group), an arylsulfonyl group, an alkylsulfinyl group, an arylsulfinyl group, a phosphono group, an acyl group, a carbamoyl group, a sulfamoyl group, a sulfonamide group, a cyano group, an alkoxy group, an aryloxy group, a heterocyclicoxy group, a siloxy group, an acyloxy group, a sulfonic acid group, a salt of sulfonic acid, an aminocarbonyloxy group, an amino group, an anilino group, an imido group, an ureido group, an alkoxycarbonylamino group, an alkoxycarbonyl group, an aryloxycarbonyl group, a heterocyclicthio group, a thioureido group, a carboxyl group, a salt of carboxylic acid, a hydroxyl group, a mercapto group or a nitro group when R₁-R₆ is a substituent.

2. The optical film as described in item 1 above, wherein the polymerizable group is an unsubstituted ethylene series polymerizable group.
3. The optical film as described in items 1 or 2 above, wherein the polymerizable group contains a group selected from the group consisting of an acryloyl group, a methacryloyl group, and a styryl group.
4. The optical film as described in items 1 through 3 above, which comprises cellulose ester.
5. A manufacturing method of the optical film as described in items 1 through 4 above, which is manufactured by a melt-cast method.
6. A polarizing plate having the optical film as described in items 1 through 4 above, at least on one surface of a polarizing element.
7. A liquid crystal display device using the polarizing plate as described in item 6 through 4 above, at least one surface of a liquid crystal cell.

### ADVANTAGE OF THIS INVENTION

This invention can provide an optical film, which is good in haze and generates no deformation defects of a master roll such as a horseback defect and a convex defect even after long term storage, a manufacturing method of the optical film, as well as a polarizing plate using it and a liquid crystal display using the polarizing plate.

### BRIEF DESCRIPTION OF THE DRAWINGS

FIG. 1 is a schematic flow sheet to show an embodiment to practice a manufacturing method of cellulose ester film according to the present invention.

FIG. 2 is an enlarged flow sheet of a primary portion of the manufacturing apparatus of FIG. 1.

FIG. 3 (a) is an outlook drawing of a casting die.

FIG. 3 (b) is a cross-sectional view of the primary portion of a casting die.

FIG. 4 is a cross-sectional view of the first embodiment of a sandwich press rotator.

FIG. 5 is a cross-sectional view of the second embodiment of a sandwich press rotator at a plane perpendicular to the rotation axis.

FIG. 6 is a cross-sectional view of the second embodiment of a sandwich press rotator at a plane including the rotation axis.

FIG. 7 is an analytical oblique view to show a brief constitution of a liquid crystal display.

FIGS. 8(a)-8(c) are drawings to show a storing state of a film master roll for a display.

### DESCRIPTION OF SYMBOLS

1: Extruder
2: Filter
3: Static mixer
4: Casting die
5: Rotary supporting member (first cooling roll)
6: Pressure rotary member (touch roll)
7: Rotary supporting member (second cooling roll)
8: Rotary supporting member (third cooling roll)
9, 11, 13, 14 and 15: Conveying roll
10: Cellulose acylate film
16: Winding device
21a, 21b: Protective film
22a, 22b: Phase difference film
23a, 23b: Retarded axis of the film
24a, 24b: Transmission axis of the film
25a, 25b: Polarizer
26a, 26b: Polarizing plate
27: Liquid crystal cell
29: Liquid crystal display apparatus
31: Die main body
32: Slit
41: Metal sleeve
42: Elastic roller
43: Metallic inner sleeve
44: Rubber
45: Cooling water
51: Outer sleeve
52: Inner sleeve
53: Space
54: Coolant
55a and 55b: Rotary shafts
56a and 56b: Outer sleeve supporting flanges
60: Fluid shaft sleeve
61a and 61b: Inner sleeve supporting flanges
62a and 62b: Intermediate passages
110: Core of a roll
117: Support board
118: Mount
120: Master roll of cellulose ester film

### Preferable Embodiment of the Invention

Preferable embodiment of the invention is described below. The present invention is not restricted thereto.

This invention is characterized by that the optical film comprises at least one high molecular compound derived from a compound represented by the Formula (1) as described above.

### <Compound Represented by the Formula (1)>

The compound represented by the Formula (1) will be described.

In the formula (1), R₁-R₆ are a hydrogen atom or a substituent. The substituents represented by R₁-R₆ are not specifically limited, and, include an alkyl group (such as a methyl group, an ethyl group, a propyl group, an isopropyl group, a t-butyl group, a pentyl group, a hexyl group, an octyl group, a dodecyl group and trifluoromethyl group), a cycloalkyl group (such as a cyclopentyl group and a cyclohexyl group), an aryl group (such as a phenyl group and a naphthyl group), an acylamino group (such as an acetylamino group and a benzoylamino group), an alkylthio group (such as a methylthio group and an ethylthio group), an arylthio group (such as a phenylthio group and a naphthylthio group), an alkenyl group (such as a vinyl group, a 2-propenyl group, a 3-butenyl group, a 1-methyl-3-propenyl group, a 3-pentenyl group, a 1-methyl-3-butenyl group, a 4-hexenyl group and a cyclohexenyl group), a halogen atom (such as a fluorine atom, a chlorine atom, a bromine atom and an iodine atom), an alkynyl group (such as a propargyl group), a heterocyclic group (such as a pyridyl group, a thiazolyl group, an oxazolyl group and an imidazolyl group), an alkylsulfonyl group (such as a methylsulfonyl group and an ethylsulfonyl group), an arylsulfonyl group (such as a phenylsulfonyl group and a naphthylsulfonyl group), an alkylsulfinyl group (such as a methylsulfinyl group), an arylsulfinyl group (such as a phenylsulfinyl group), a phosphono group, an acyl group (such as an acetyl group, a pivaloyl group and a benzoyl group), a carbamoyl group (such as an aminocarbonyl group, a methylaminocarbonyl group, a dimethylaminocarbonyl group, a butylaminocarbonyl group, a cyclohexylaminocarbonyl group, a phenylaminocarbonyl group and a 2-pyridylaminocarbonyl group), a sulfamoyl group (such as an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group and a 2-pyridylaminosulfonyl group), a sulfonamide group (such as a methanesulfonamide group and a benzenesulfonamido group), a cyano group, an alkoxy group (such as a methoxy group, an ethoxy group and a propoxy group), an aryloxy group (such as a phenoxy group and a naphthyloxy group), a heterocyclicoxy group, a siloxy group, an acyloxy group (such as an acetyloxy group and a benzoyloxy group), a sulfonic acid group, a salt of sulfonic acid, an aminocarbonyloxy group, an amino group (such as an amino group, an ethylamino group, a dimethylamino group, a butylamino group, a cyclopentylamino group, a 2-ethylhexylamino group and a dodecylamino group), an anilino group (such as a phenylamino group, a chlorophenylamino group, a toluidino group, an anisidino group, a naphthylamino group and a 2-pyridylamino group), an imido group, a ureido group (such as a methylureido group, an ethylureido group, a pentylureido group, a cyclohexylureido group, an octylureido group, a dodecylureido group, a phenylureido group, a naphthylureido group and a 2-pyridylureido group), an alkoxycarbonylamino group (such as a methoxycarbonylamino group and a phenoxycarbonylamino group), an alkoxycarbonyl group (such as methoxycarbonyl group, ethoxycarbonyl group and phenoxycarbonyl group), an aryloxycarbonyl group (such as a phenoxycarbonyl group), a heterocyclicthio group, a thioureido group, a carboxyl group, a salt of carboxylic acid, a hydroxyl group, a mercapto group and a nitro group. These groups may be further substituted by a similar substituent.

In the formula (1), R₁ and R₂ may be a substituent bonded via double bond together.

In the formula (1), at least one of groups represented by R₁-R₆ is a group having a polymerizable group as a partial structure. The polymerizable group in this invention is an unsaturated ethylene series polymerizable group, a bifunctional condensation polymerizable group, or a bifunctional addition polymerizable group. The unsaturated ethylene series polymerizable group is preferable. Practical examples of the unsaturated ethylene series polymerizable group include a vinyl group, an allyl group, an acryloyl group, a methacryloyl group, a styryl group, an acrylamide group, a methacrylamide group, a vinyl cyanide group, a 2-cyanoacryloxy group, a 1,2-epoxy group, a vinylbenzyl group, and a vinylether group. The term of a group having a polymerizable group as a partial structure means that the above described polymerizable group is bonded directly or through a divalent or more valent bonding group. The divalent or more valent bonding group includes an alkylene group (such as methylene, 1,2-ethylene, 1,3-propyrene, 1,4-butyrene, and cyclohexane-1,4-diyl), an alkenylene group (such as ethane-1,2-diyl, and butadiene-1,4-diyl), an alkynylene group (such as ethyne-1,2-diyl, and butane-1,3-diyn-1,4-diyl), a bonding group derived from a compound containing at least one of aromatic group, (such as substituted or non substituted benzene, condensed polycyclic hydrocarbon, aromatic heterocycle, aromatic hydrocarbon cycle assemble and aromatic heterocycle assemble. The preferable example is an alkylene group and/or a group bonding via hetero atom. These bonding groups may form a composite group in combination together.

An unsaturated ethylene series polymerization group is preferable as the polymerization group, and an acryloyl group, a methacryloyl group and a styryl group are more preferable, and an acryloyl group and a methacryloyl group particularly preferable.

<High Molecular Compound Derived from a Compound Represented by Formula (1)>

High molecular compound derived from a compound represented by Formula (1), which may be referred to polymer, is detailed.

The high molecular compounds in relation to this invention are classified in terms of reaction deriving from the compound of this invention represented by Formula (1) into an addition polymerization polymer, a ring opening polymerization polymer, an addition polymerization polymer, a condensation polymerization polymer, and an addition condensation polymer. An addition polymerization polymer and a ring opening polymerization polymer are preferable, and addition polymerization polymer is more preferable in this invention. The addition polymerization polymer includes a vinyl polymer and a diene polymer, and a vinyl polymer is preferable in this invention.

The high molecular compounds in relation to this invention are classified in terms of shape into a linear high molecular, a two dimensional high molecular and a three dimensional high molecular. The linear high molecular and the two dimensional high molecular are preferable, and linear high molecular is more preferable in this invention.

In case that the high molecular compound derived from a compound represented by Formula (1) related to this invention is a polymer, the polymer may be a homopolymer derived from the compound represented by Formula (1) solely or a copolymer with another polymerizable compound. The high molecular compound in relation to this invention contains in the polymer at least two compound unit represented by the Formula (1) in any case of a homopolymer or a copolymer. A copolymer is preferably used in this invention.

Another polymerizable compound capable of copolymerization includes unsaturated compounds, for example, a styrene derivative (such as styrene, α-methylstyrene, o-methylstyrene, m-methylstyrene, p-methylstyrene and vinyl naphthalene), an acrylate derivative (such as methyl acrylate, ethyl acrylate, propyl acrylate, butyl acrylate, i-butyl acrylate, t-butyl acrylate, octyl acrylate, cyclohexyl acrylate, and benzyl acrylate), a methacrylate derivative (such as methyl methacrylate, ethyl methacrylate, propyl methacrylate, butyl methacrylate, i-butyl methacrylate, t-butyl methacrylate, octyl methacrylate, cyclohexyl methacrylate, and benzyl methacrylate), an alkyl vinylether (such as methyl vinylether, ethyl vinylether, and butyl vinylether), an alkyl vinylester (such as vinyl formate, vinyl acetate, vinyl butylate, vinyl caproate, and vinyl stearate), crotonic acid, maleic acid, fumaric acid, itaconic acid, acrylonitrile, methacrylonitrile, vinyl chloride, vinylidene chloride, acrylamide, and methacrylamide. Preferable examples are methylacrylate, methylmethacrylate and vinyl acetate.

The other polymerizable compound capable of copolymerization includes hydrophilic ethylenical unsaturated compounds. The hydrophilic ethylenical unsaturated compound includes a compound, without restriction, as far as it is hydrophilic and contains a polymerizable unsaturated double bond in a molecule, examples of which include unsaturated carboxylic acid such as acrylic acid and methacrylic acid, acrylate or methacrylate having a hydroxy group or a ether bond (such as 2-hydroxyethyl methacrylate, 2-hydroxypropyl methacrylate, tetrahydrofurfuryl methacrylate, 2-hydroxyethyl acrylate, 2-hydroxypropyl acrylate, 2,3-dihydroxy-2-methylpropyl methacrylate, tetrahydrofurfuryl acrylate, 2-ethoxyethyl acrylate, diethyleneglycol ethoxylate acrylate, and 3-methoxybutyl acrylate), acrylamide, N-substituted (meth)acryl amide such as N,N-dimethyl(meth)acrylamide, N-vinyl pyrrolidone, and N-vinyl oxazolidine.

Preferable examples of a hydrophilic ethylenical unsaturated compound include (meth)acrylate having a hydroxyl or carboxyl group in a molecule, particularly preferable are 2-hydroxyethyl methacrylate, 2-hydroxypropyl methacrylate, 2-hydroxyethyl acrylate, and 2-hydroxyethyl acrylate.

The compound represented by Formula (1) of this invention may be copolymerized with various functional compounds having a polymerizable group, for example, a polymerizable compound having U.V. ray absorbing function disclosed in JP-A 2003-113317.

On or more of these compounds may be copolymerized with the compound represented by Formula (1)

A copolymer composed of three components, and it is preferable to contain at least one hydrophilic ethylenical unsaturated compound as a copolymer component other than the compound represented by Formula (1), in case that the high molecular compound derived from a compound represented by Formula (1) is a copolymer in this invention. Content of the hydrophilic ethylenical unsaturated compound in the copolymer is preferably 5-30% by weight and more preferably 10-20% by weight.

Known methods can be employed to obtain a high molecular compound derived from a compound represented by Formula (1) related to this invention without particular limitation, and examples include radical polymerization, anion polymerization, and cation polymerization. An initiator used in the radical polymerization is, for example, azo compound and peroxides, concretely, azobis isobutyronitrile (AIBN), azobis isobutyric acid diester derivative, peroxy benzoyl, and hydrogen peroxide. Solvents used in the polymerization are not particularly limited and examples thereof include an aromatic hydrocarbon solvent such as toluene and chlorobenzene, a halogenated hydrocarbon solvent such as dichloroethane and chloroform, an ether solvent such as tetrahydrofuran and dioxane, an amide solvent such as dimethyl formamide, an alcohol solvent such as methanol, an ester solvent such as methyl acetate and ethyl acetate, a ketone solvent such as acetone, cyclohexane and methylethyl ketone, and an aqueous solvent. Polymerization methods of solution polymerization reacted in homogenous system, precipitation polymerization in which polymer precipitates are generated, emulsion polymerization polymerized in micelle state, suspension polymerization polymerized in suspension state and bulk polymerization if case allowed by selecting the solvent.

Ratio of amount of the compound represented by Formula (1) to that of a copolymerizable compound is optionally selected by considering effect to compatibility of targeted high molecular compound to other resin, transparency and mechanical strength of the optical film.

It is preferable that the content of a compound represented by Formula (1) in a high molecular compound derived from the compound represented by Formula (1) is 1-70 t by weight, and more preferably 5-60% by weight in this invention. When the content of the compound represented by Formula (1) is less than 1% by weight, much amount of the high molecular compound must be used to satisfy the desired property, and this becomes a factor to deteriorate transparency due to increase of haze or precipitation, or film strength. When the content of the compound represented by Formula (1) is more than 70% by weight, it causes to reduce compatibility to other high molecular compound, and transparent film can not be obtained. Further, workability and production efficiency deteriorates because solubility in a solvent reduced.

Weight average molecular weight of the high molecular compound derived from the compound represented by Formula (1) is usually 500-100,000, preferably 1,000-50,000, more preferably 3,000-30,000, and particularly preferably 5,000-15,000.

The weight average molecular weight is measured by employing gel permeation chromatography in the following condition.

### Solvent: Tetrahydrofuran

### Apparatus: HLC-8220 (by Toso Co., Ltd.)

### Column: TSK gel Super HM-M (by Toso Co., Ltd.)

Column temperature: 40° C.
Sample temperature: 0.1% by mass

### Dose: 10 μl

Flow rate: 0.6 ml/min.
Calibration curve: Standard polystyrene: PS-1 (by Polymer Laboratories Inc.)

Based on a calibration curve having Mw=2,560,000 through 580 using nine samples.

It is preferable that the content of an adding amount of the high molecular compound derived from a compound represented by Formula (1) is 0.01-10% by weight, and more preferably 0.1-5% by weight, and further preferably 0.2-2% by weight based on the resin mentioned later, converted into the weight of the compound represented by Formula (1) in this invention. These may be used two or more kinds in combination.

Concrete examples of the compound represented by the formula (1) are shown below. The present invention is not restricted to these.

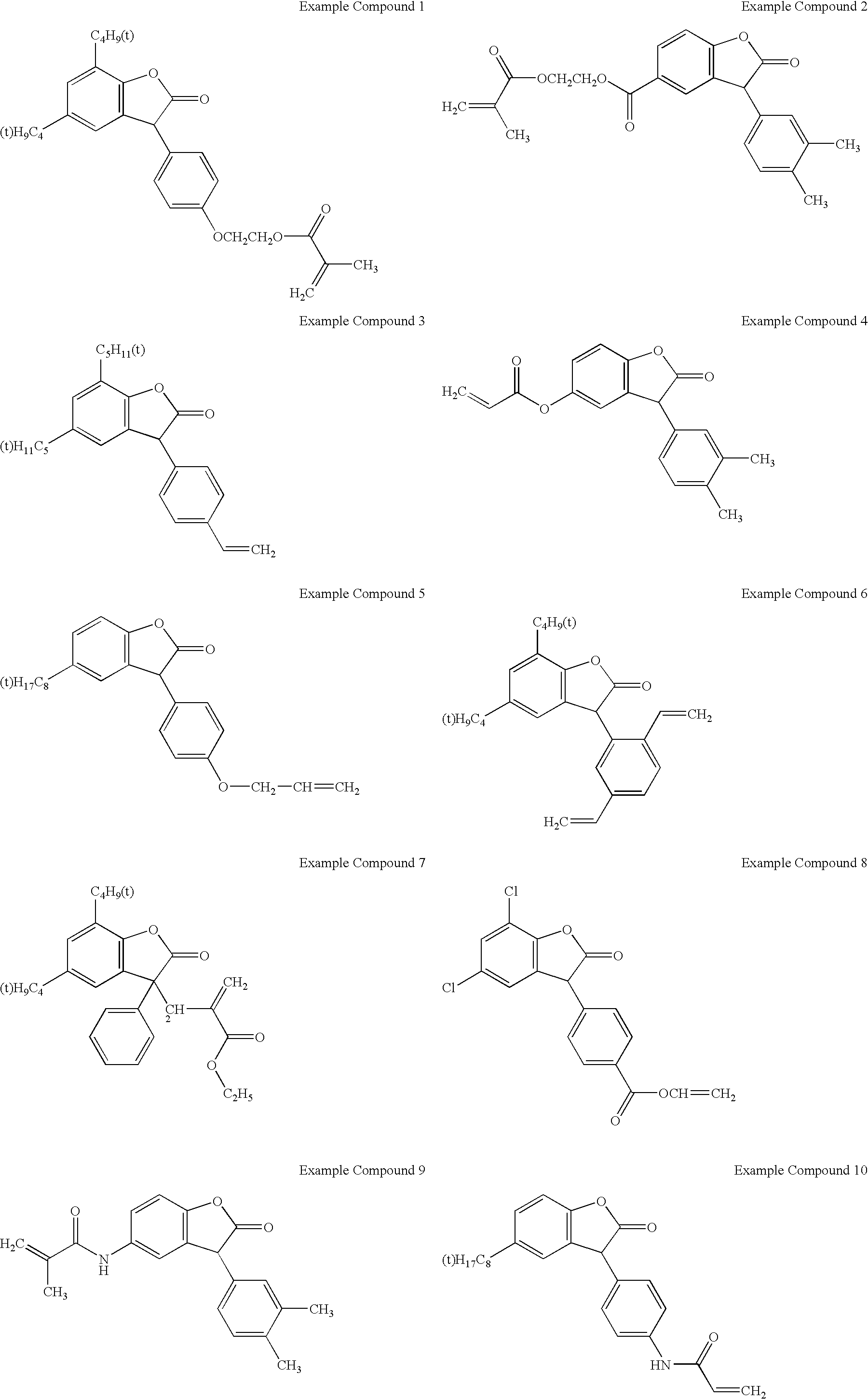

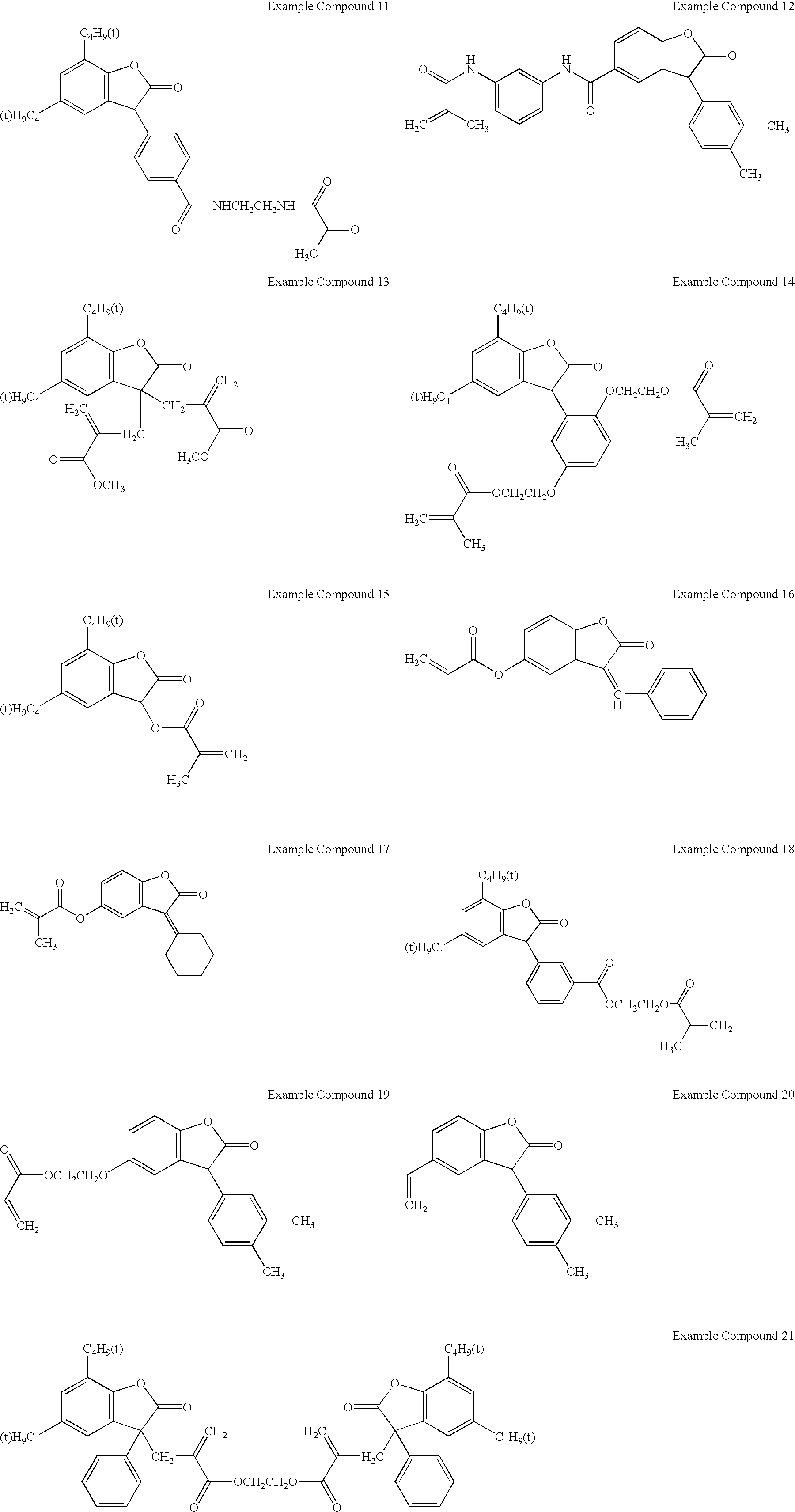

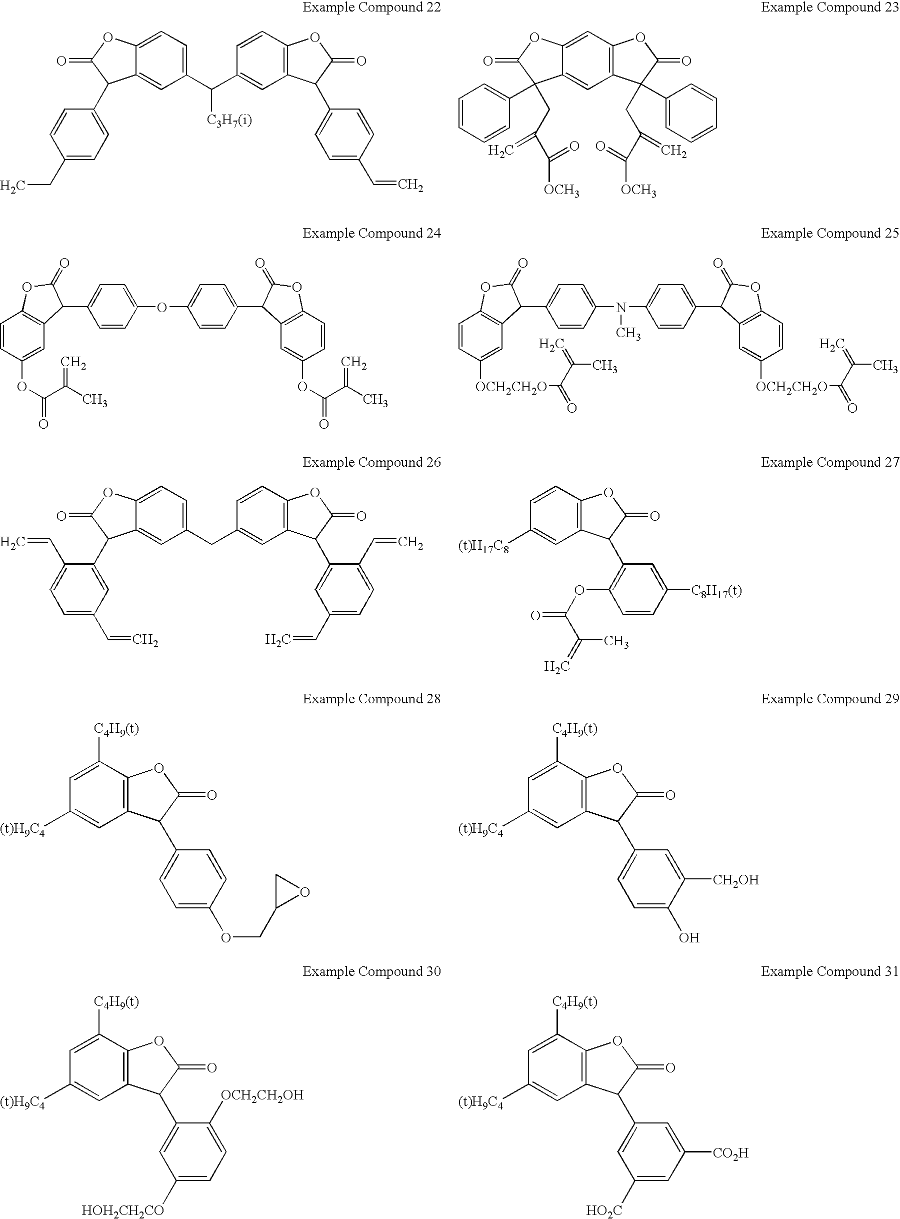

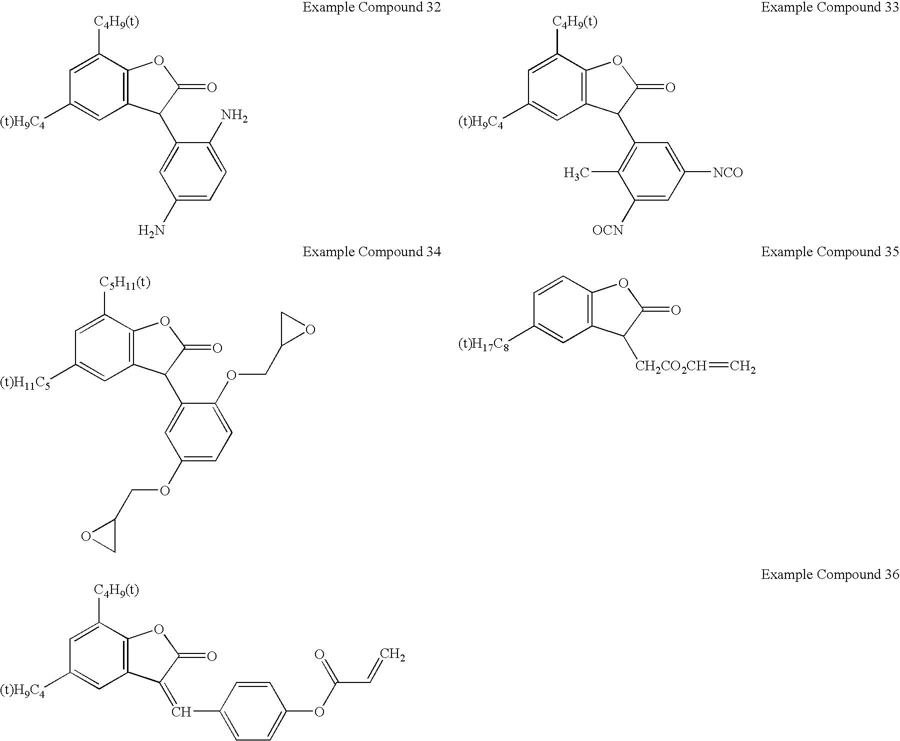

The high molecular compounds derived from the compound A through M listed in Table 1 and N through W are exemplified. The present invention is not restricted to these.

TABLE 1

| High | | | | | | | |
|---|---|---|---|---|---|---|---|
| Molecular | Polymerizable | | Polymerizable | | Polymerizable | | |
| Compound | Compound | | Compound | | Compound | | Mw*** |
| A | Example | 35% | MMA* | 50% | 2-HEMA** | 15% | 14,000 |
| | Compound 1 | | | | | | |
| B | Example | 35% | MMA* | 50% | 2-HEMA** | 15% | 10,000 |
| | Compound 1 | | | | | | |
| C | Example | 35% | MMA* | 50% | 2-HEMA** | 15% | 5,000 |
| | Compound 1 | | | | | | |
| D | Example | 10% | MMA* | 70% | 2-HEMA** | 20% | 10,500 |
| | Compound 1 | | | | | | |
| E | Example | 10% | MMA* | 80% | 2-HEMA** | 10% | 10,300 |
| | Compound 1 | | | | | | |
| F | Example | 35% | MMA* | 50% | 2-HEMA** | 15% | 9,800 |
| | Compound 2 | | | | | | |
| G | Example | 35% | MMA* | 50% | 2-HEMA** | 15% | 16,000 |
| | Compound 3 | | | | | | |
| H | Example | 35% | MMA* | 50% | 2-HEMA** | 15% | 11,000 |
| | Compound 7 | | | | | | |
| I | Example | 35% | MMA* | 50% | 2-HEMA** | 15% | 22,000 |
| | Compound 9 | | | | | | |
| J | Example | 35% | MMA* | 50% | 2-HEMA** | 15% | 3,000 |
| | Compound | | | | | | |
| | 15 | | | | | | |
| K | Example | 35% | MMA* | 50% | 2-HEMA** | 15% | 9,500 |
| | Compound | | | | | | |
| | 18 | | | | | | |
| L | Example | 35% | MMA* | 50% | 2-HEMA** | 15% | 15,000 |
| | Compound | | | | | | |
| | 19 | | | | | | |
| M | Example | 40% | MMA* | 60% | | | 9,000 |
| | Compound 1 | | | | | | |

MMA*: Methyl methacrylate,
2-HEMA**: 2-Hydroxyethyl methylmethacrylate
Mw***: Weight average molecular weight

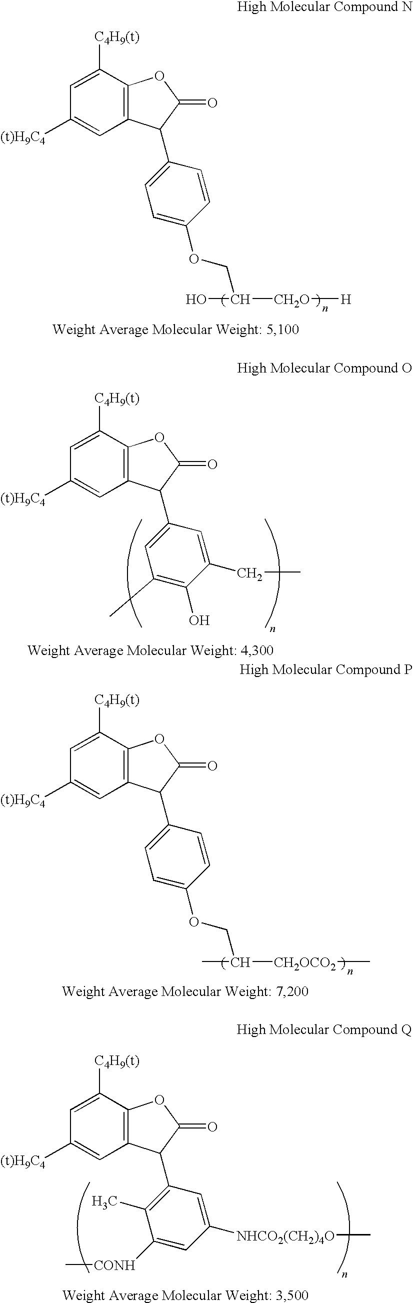

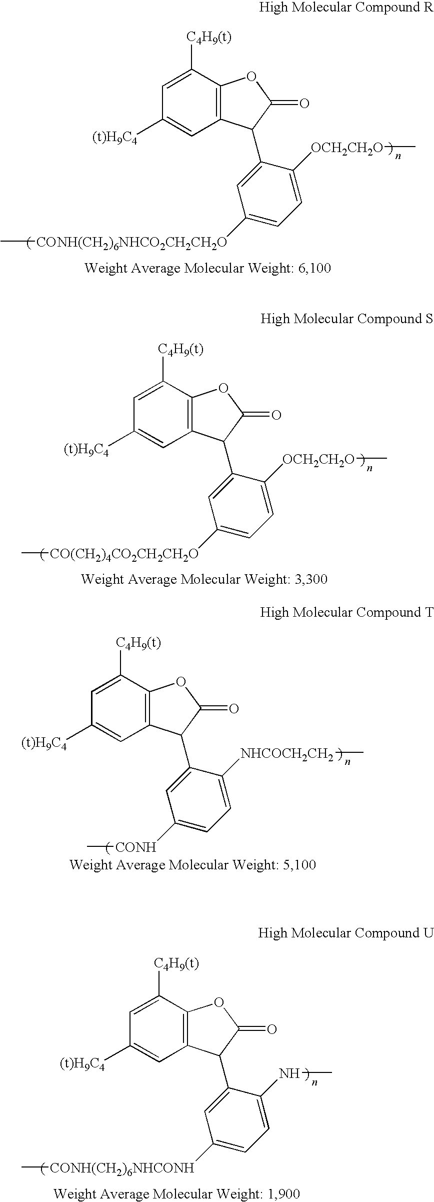

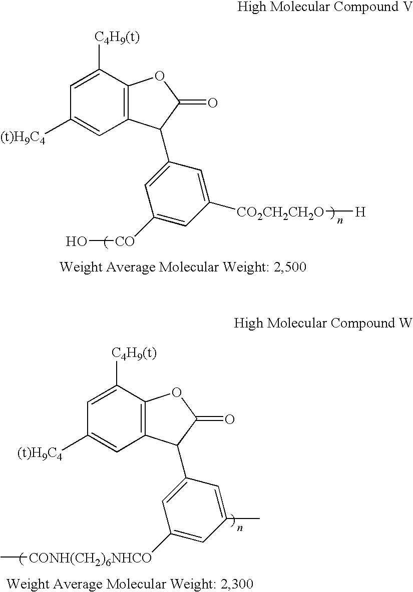

### Synthesis Example

Synthesis method of a compound represented by the Formula (1) and a high molecular compound derived therefrom related to this invention is described practically. The present invention is not limited to these.

### Synthesis Example 1

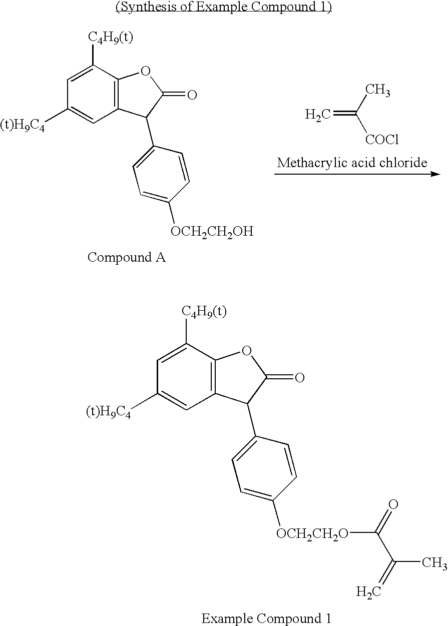

To 50 ml of toluene 3.8 g of Compound A, 2.4 g of pyridine, and 0.01 g of hydroquinone are added. Methyl methacrylate in an amount of 1.2 g is dripped thereto with stirring at room temperature, after dripping, temperature is raised up to 80° C., and they are subjected to reaction for 3 hours. After completion of reaction, toluene phase is washed with dilute hydrochloric acid and aqueous solution of baking soda in this order, concentrated by a rotary evaporator, the obtained residue is recrystallized from mixture solvent of acetonitrile and ethanol to obtain 3.8 g of solid. The obtained solid is identified to the Compound by analysis via ¹H-NMR and mass spectrum.

### Synthesis Example 2

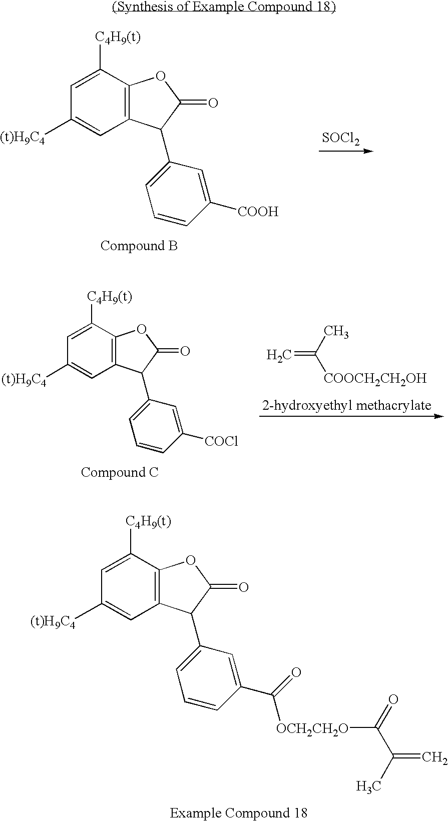

To 20 ml of toluene 3.7 g of Compound B is added, and ml of thionyl chloride and 0.20 ml of N,N-dimethylformamide are added with stirring, temperature is raised up to 60° C., and they are subjected to reaction for one hour. Solvent is removed by evaporation via rotary evaporator after the completion of reaction, 40 ml of toluene is added to the residue (Compound C), and heated to dissolve it. In another vessel 20 ml of toluene, 0.01 g of hydroquinone, 2.0 g of 2-hydroxyethyl methacrylate and 1.28 g of pyridine are added and hated up to 50° C. Toluene solution of Compound C as prepared above is dripped thereto, after dripping temperature is raised up to 80° C., and they are subjected to reaction for three hours. After completion of reaction, toluene phase is washed with dilute hydrochloric acid and aqueous solution of baking soda in this order, concentrated by a rotary evaporator, the obtained residue is recrystallized from mixture solvent of acetonitrile and methanol to obtain 4.1 g of solid. The obtained solid is identified to the Compound 18 by analysis via ¹H-NMR and mass spectrum.

### Synthesis Example 3

### Synthesis of High Molecular Compound A

To 50 ml of tetrahydrofuran, 3.5 g of Example Compound 1 synthesized by Synthesis Example 1 as described above, 5.0 g of methyl methacrylate and 1.5 g of 2-hydroxyethyl methacrylate are added. Then, 1.14 g of azoisobutyronitrile is added. They are refluxed with heating for 8 hours in the nitrogen gas ambient. Tetrahydrofuran is removed by reduced pressure evaporation, the residue is dissolved again in 20 ml of tetrahydrofuran, and is dripped into much excess amount of methanol. Deposited precipitate is collected by filtration, vacuum dried at 40° C. to obtain 9.0 g of white powder High Molecular Compound A. Weight average molecular weight of this polymer is determined 14,000 by GPC analysis of standard polystyrene reference. It is determined as a copolymer having composing ratio of (Example Compound 1):methyl methacrylate:2-hydroxyethyl methacrylate being about 35:50:15 by NMR analysis.

### Synthesis Example 4

### Synthesis of High Molecular Compound B

High Molecular Compound B is obtained by the same way as Synthesis Example 3 described above, except that the amount of azoisobutyronitrile is changed as 2.28 g. Weight average molecular weight of this polymer is determined 10,000 by GPC analysis of standard polystyrene reference. It is determined as a copolymer having composing ratio of (Example Compound 1):methyl methacrylate:2-hydroxyethyl methacrylate being about 35:50:15 by NMR analysis.

### Synthesis Example 5

### Synthesis of High Molecular Compound C

To 50 ml of toluene, 3.5 g of Example Compound 1 synthesized by Synthesis Example 1 as described above, 5.0 g of methyl methacrylate and 1.5 g of 2-hydroxyethyl methacrylate are added. Then, 2.85 g of azoisobutyronitrile is added. They are heated at 70° C. for 8 hours in the nitrogen gas ambient. Toluene is removed by reduced pressure evaporation, the residue is dissolved in 20 ml of toluene again, and is dripped into much excess amount of methanol. Deposited precipitate is collected by filtration, vacuum dried at 40° C. to obtain 9.5 g of white powder High Molecular Compound A. Weight average molecular weight of this polymer is determined 5,000 by GPC analysis of standard polystyrene reference. It is determined as a copolymer having composing ratio of (Example Compound 1):methyl methacrylate:2-hydroxyethyl methacrylate being about 35:50:15 by NMR analysis.

### Synthesis Example 6

### Synthesis of High Molecular Compound E

To 50 ml of toluene, 1.0 g of Example Compound 1 synthesized by Synthesis Example 1 as described above, 8.0 g of methyl methacrylate and 1.0 g of 2-hydroxyethyl methacrylate are added. Then, 1.14 g of azoisobutyronitrile is added. They are heated at 70° C. for 8 hours in the nitrogen gas ambient. Toluene is removed by reduced pressure evaporation, the residue is dissolved in 20 ml of toluene again, and is dripped into much excess amount of methanol. Deposited precipitate is collected by filtration, vacuum dried at 40° C. to obtain 9.2 g of white powder High Molecular Compound A. Weight average molecular weight of this polymer is determined 10,300 by GPC analysis of standard polystyrene reference. It is determined as a copolymer having composing ratio of (Example Compound 1):methyl methacrylate:2-hydroxyethyl methacrylate being about 10:80:10 by NMR analysis.

### <Optical Film>

The optical film of this invention is described.

The optical film according to this invention includes a functional film used for various display devices such as a liquid crystal display, a plasma display and an organic EL display, and more in detail, a polarizing plate protect film, a phase difference film, anti-reflection film, a brightness enhancing film, a hard-coat film, an anti-glare film, an anti-static film and an optical compensation film such as an angular field of view extending film for a liquid crystal display device.

Resins used for a resin film as a substrate of the optical film of this invention includes cellulose ester resins, polycarbonate resins, polystyrene resins, polysulfone resins, polyester resins, polyallylate resin, acryl resins, olefin resins (such as norbornane resins, cyclic olefin resins cyclic conjugate diene resins and vinyl alicyclic hydrocarbon resins). Cellulose ester resins, polycarbonate resins and cyclic olefin resins are preferable among them, and the cellulose ester resins are specifically preferable.

These resins may be used in combination together, for example, cellulose ether resins, polyvinyl resins (including polyvinyl acetate resin and polyvinyl alcohol resins), cyclic olefin resins, polyester resins (aromatic polyesters, aliphatic polyesters or copolymers thereof), aryl resins (including copolymers) may be incorporated in addition to cellulose ester resins. Content of the resins other than cellulose ester resin is preferably 0.1-30% by weight.

The optical film related to this invention is used for preferably a polarizing plate protect film, a phase difference film, and an optical compensation film, and used for a polarizing plate protect film particularly preferable.

The optical film of this invention preferably employs cellulose ester film containing a high molecular compound derived from a compound represented by Formula (1) as a substrate.

### <Cellulose Ester>

The following describes the details of the cellulose ester and an optical film having the cellulose ester which is a preferable embodiment of the present invention:

The cellulose ester film used in the present invention is manufactured by a solution casting method or a melt casting method. In the solution casting method, a solution (dope) with a cellulose ester dissolved in a solvent is cast on the support member and the solvent is evaporated to produce a film. In the melt casting, a cellulose ester is molten by heating, and the resultant product (melt) is extruded from a die to form a film and the extruded film is cooled on a cooling drum. The melt casting method permits a substantial reduction in the amount of the organic solvent used to produce the film. As compared with the solution casting method requiring use of a great amount of conventional organic solvent, the melt casting method provides a film characterized by a substantial improvement in environmental adaptability. Thus, the cellulose ester film is preferably manufactured by the melt casting method.

The melt casting method of the present invention is a method of producing a film by heating and melting a cellulose ester up to the temperature wherein it becomes fluid, virtually without using a solvent. It is exemplified by the method of producing a film by extruding fluid cellulose ester through a die. The solvent may be used in part of the process of preparing the molten cellulose ester. In the melt film formation process for forming a film product, film forming operation is performed without using solvent.

There is no restriction to the cellulose ester constituting the polarizer protective film if it is a cellulose ester that can be molten to form a film. It is used for aromatic carboxylic acid ester and others. When the film properties obtained such as optical properties are taken into account, the lower fatty acid ester of cellulose is preferably used. In the present invention, the lower fatty acid in lower fatty acid ester cellulose is defined as a fatty acid containing 5 or less carbon atoms. Cellulose acetate, cellulose propionate, cellulose butyrate and cellulose pivalate can be mentioned as preferable lower fatty acid esters of cellulose. Although the cellulose ester replaced by the fatty acid containing six or more carbon atoms has a good melt film formation property, the cellulose ester film having been obtained therefrom has poor dynamic characteristics. This cellulose ester can hardly be used as an optical film. To ensure compatibility between the dynamic characteristics and melt casting film formation property, it is preferred to use a mixed fatty acid ester such as cellulose acetate propionate and cellulose acetate butyrate. Triacetyl cellulose which is a cellulose ester commonly used in a solution cast film formation method is difficult to be used in a melt casting film formation method, since the melting temperature of triacetyl cellulose is higher than the decomposition temperature.

The cellulose esters preferably used are cellulose acetate propionate and cellulose acetate butyrate among those mentioned above.

A degree of substitution of an acyl group in the cellulose acetate is described.

Cellulose acylate has three hydroxyl groups bonded to the carbon atoms at 2-, 3- and 6-positions of the glucose unit. The total substitution degree by acyl group is a measure representing the number of the hydroxyl groups bonded with the acyl groups. Accordingly, the substitution degree comes up to the maximum of 3.0. The acyl groups may be substituted in average or having variation at 2-, 3 and 6-positions per glucose unit.

A degree of substitution of the lower aliphatic acid esters such as cellulose acetate propionate and cellulose acetate butyrate, which are preferred as the mixed aliphatic acid cellulose ester, have an acyl group having 2 to 4 carbon atoms as the substituent. The cellulose resin containing cellulose ester which satisfies all formulas (I), (II) and (III) below, are preferred, wherein X represents a degree of substitution of the acetyl group; and Y represents a degree of substitution of the propionyl group or the butyryl group. The substitution degree of the acyl group can be measured according to ASTM-D817-96.

2.4≦X+Y≦2.9 formula (I)

0≦X≦2.4 formula (II)

0.5≦Y≦2.9 formula (III)

Cellulose acetate propionate is preferably used herein, and of the cellulose acetate propionates, those that satisfy 1.2≦X≦2.1 and 0.6≦Y≦1.4 are particularly preferable.

It is allowed that the optical film satisfied the above condition by blending cellulose esters having different acyl substitution degree of substitution, as a whole. A portion, which is not substituted with acyl group, usually exists as a hydroxy group. These may be synthesized by a known method.

The number average molecular weight (Mn) of the cellulose ester used in the optical film of this invention is preferably 50,000-150,000, more preferably 55,000-120,000, and particularly preferably 60,000-100,000.

In the cellulose ester used in the invention, the ratio of the weight average molecular weight Mw/number average molecular weight Mn is preferably 1.3-5.5, while 1.5-5.0 is particularly preferable, 1.7-4.0 is more preferable and 2.0-3.5 is even more preferable.

The Mn and Mw/Mn of cellulose ester were measured by a gel permeation chromatography in the following method. Measuring condition is listed:
Solvent: Tetrahydrofuran
Apparatus: HLC-8220 (Manufactured by Toso Corp.)
Column: TSK gel Super HM-M (Manufactured by Toso Corp.)
Temperature: 40° C.
Sample concentration: 0.1% by weight
Injection amount: 10 μl
Flow rate: 0.6 ml/min
Calibration curve: Nine samples of Standard polystyrene PS-1 Standard (Manufactured by Polymer Laboratories), the Mw being in the range of 2,560,000-580. Thirteen samples are used almost same interval.

The cellulose which is the raw material for the cellulose ester of the invention may be wood pulp or cotton linter, and the wood pulp may be that of a needle-leaf tree or a broad-leaf tree, but that of the broad-leaf tree is more preferable. Cotton linter is preferably used in view of peeling properties at the time of film formation. Cellulose esters made from these substances may be suitably blended or used alone.

For example, the proportion used of cellulose ester from cotton linter: cellulose ester from wood pulp (needle-leaf tree): cellulose ester from wood pulp (broad-leaf tree) may be 100:0:0, 90:10:0, 85:15:0, 50:50:0, 20:80:0, 10:90:0, 0:100:0, 0:0:100, 80:10:10, 85:0:15, and 40:30:30.

The cellulose ester can be obtained, for example, by substituting the hydroxyl group of the material cellulose by the acetic anhydride, anhydrous propionic acid and/or anhydrous butyric acid according to the normal method in such a way that the acetyl group, propionyl group and/or butyl group are kept within the aforementioned range. There is no restriction to the method of synthesizing such a cellulose ester. For example, it can be synthesized by using the method disclosed in JP-A No. H10-45804, or No. H06-501040.

Content of alkali earth metal used in the cellulose ester of this invention is preferably 1-50 ppm. It is liable to increase of lip attaching stain, or to break at thermal stretching process or slitting process after thermal stretching at 50 ppm or more. It is also liable to break when the content being less than 1 ppm, the reason of which is not known. Load against washing process so as to make less than 1 ppm is too heavy, and therefore it is not preferable. The content of 1-30 ppm is more preferable. The alkali earth metals means a total amount of calcium and magnesium, that is measured by employing X ray photoelectron spectrometric analysis (XPS).

The amount of the residual sulfuric acid contained in the cellulose ester used in the present invention is 0.1 through 45 ppm in terms of the sulfur element. They are considered to be included as salts. The amount of the residual sulfuric acid contained therein of not less than 45 ppm is not preferable since the deposition on the die lip at the time of heat-melting increases and the film tends to tear off at the time of thermal stretching or slitting subsequent to thermal stretching. The amount of the residual sulfuric acid contained therein should be reduced as much as possible, but when it is to be reduced below 0.1 ppm, the load on the cellulose ester washing process will be excessive and the material tends to be damaged easily. This should be avoided. This may be because an increase in the frequency of washing affects the resin, but the details are not yet clarified. Further, the preferred amount is in the range of 1 through 30 ppm. The amount of the residual sulfuric acid can be measured according to the ASTM-D817-96 in the similar manner.

The total amount of the free acid in the cellulose ester used in this invention is preferably 1-500 ppm. The deposition on the die lip at the time of heat-melting increases and the film tends to tear off, when excess 500 ppm. It is difficult to make less than 1 ppm by washing. It is more preferable of 1-100 ppm, and it increase resistance to tear. Particularly preferable is 1-70 ppm. The amount of free acid can be measured according to the ASTM-D817-96.

The amount of the residual acid can be kept within the aforementioned range if the synthesized cellulose ester is washed more carefully than in the case of the solution casting method. Then, when a film is manufactured by the melt casting, the amount of depositions on the lip portion will be reduced so that a film characterized by a high degree of flatness is produced. Such a film will be further characterized by excellent resistance to dimensional changes, mechanical strength, transparency, resistance to moisture permeation, Rth value and Ro value to be described later. Further, the cellulose ester can be washed using water as well as a poor solvent such as methanol or ethanol. It is also possible to use a mixture between a poor solvent and a good solvent if it is a poor solvent as a result. This will remove the inorganic substance other than residual acid, and low-molecular organic impurities. The cellulose ester is washed preferably in the presence of an antioxidant such as a hindered amine and phosphorous acid ester. This will improve the heat resistance and film formation stability of the cellulose ester.

To improve the heat resistance, mechanical property and optical property of the cellulose ester, the cellulose ester is settled again in the poor solvent, subsequent to dissolution of the good solvent of the cellulose ester. This will remove the low molecular weight component and other impurities of the cellulose ester. In this case, similarly to the aforementioned case of washing the cellulose ester, washing is preferably carried out in the presence of an antioxidant.

Subsequent to re-settling of the cellulose ester, another polymer or a low molecular weight compound may be added.

Further, it is preferable that when the cellulose esters employed in the present invention are converted to a film, the resulting film produces minimal foreign matter bright spots. “Foreign matter bright spots” refers to the following type of spots. A cellulose ester film is placed between two polarizing plates arranged at right angles (crossed Nicols) and light is exposed on one side while the other side is viewed. When foreign matter is present, light leaks through the film and a phenomenon occurs in which foreign matter particles are seen as bright spots. During this operation, the polarizing plate, which is employed for evaluation, is composed of a protective film without any foreign matter bright spots, whereby a glass plate is preferably employed to protect polarizers. It is assumed that one of the causes of foreign matter bright spots is the presence of cellulose which has undergone no acetylation or only a low degree of acetylation. It is necessary to employ cellulose esters (or employing cellulose esters exhibiting a degree of uniform substitution). Further, it is possible to remove foreign matter bright spots in such a manner that melted cellulose esters are filtered, or during either the latter half of the synthesis process of the cellulose esters, or during the process to form precipitates, a solution is temporarily prepared and is filtered via a filtration process. Since melted resins exhibit high viscosity, the latter method is more efficient.

It is likely that as the film thickness decreases, the number of foreign matter bright spots per unit area decreases, and similarly, as the content of cellulose ester incorporated in films decreases, foreign matter bright spots decrease. The number of at least 0.01 mm foreign matter bright spots is preferably at most 200, is more preferably at most 100, is still more preferably at most 50, is still more preferably at most 30, is yet more preferably at most 10, but is most preferably zero. The number of foreign matter bright spots of 0.005-0.01 mm is preferably at most 200, is more preferably at most 100, is still more preferably at most 50, is still more preferably at most 30, is yet more preferably at most 10, but is most preferably zero.

In cases in which bright spot foreign matter is removed via melt-filtration, it is preferable to filter the melted composition composed of cellulose esters, plasticizers, degradation resistant agents, and antioxidants, rather than to filter melted individual cellulose ester, whereby bright spot foreign matter is efficiently removed. Of course, bright spot foreign matter may be reduced in such a manner that during synthesis of cellulose ester, the resulting cellulose ester is dissolved in solvents and then filtered. It is possible to filter compositions which appropriately incorporate UV absorbers and other additives. The viscosity of the melt, incorporating cellulose esters, which is to be filtered, is preferably at most 10,000 P, is more preferably at most 5,000 P, is still more preferably at most 1,000 P, but is most preferably at most 500 P. Preferably employed as filters are those conventionally known, such as glass fibers, cellulose fibers, paper filters, or fluorine resins such as tetrafluoroethylene. However, ceramic and metal filters are particularly preferably employed. The absolute filtrations accuracy of employed filters is preferably at most 50 μm, is more preferably at most 30 μm, is still more preferably at most 10 μm, but is most preferably at most 5 μm. It is possible to employ them in suitable combinations. Employed as a filter, may be either a surface type or a depth type. The depth type is more preferably employed since it is relatively free from clogging.

In another embodiment, it is also possible that the cellulose ester as a material is dissolved in a solvent at least once, and is dried and used. In this case, the cellulose ester is dissolved in the solvent together with one or more of the plasticizer, ultraviolet absorber, anti-deterioration agent, antioxidant and matting agent, and is dried and used. Such a good solvent as methylene chloride, methyl acetate or dioxolan that is used in the solution casting method can be used as the solvent. At the same time, the poor solvent such as methanol, ethanol or butanol can also be used. In the process of dissolution, it can be cooled down to −20° C. or less or heated up to 80° C. or more. Use of such a cellulose ester allows uniform additives to be formed in the molten state, and the uniform optical property is ensured in some cases.

The polarizer protective film of the present invention can be made of an adequate mixture of high molecular components other than the cellulose ester. The high molecular components to be mixed are preferably characterized by excellent compatibility with the cellulose ester compatibility. When formed into a film, the transmittance is preferably 80% or more, more preferably 90% or more, still more preferably 92% or more.

### (Antioxidant)

Since decomposition of a resin as a substrate of the optical film is accelerated not only by heat but also by oxygen, it is preferable to incorporate an antioxidant as a stabilizer in an optical film of the present invention.

Specifically, under a high temperature environment such as in a melt casting process, decomposition of the material for forming a cellulose ester film is accelerated by heat and oxygen, accordingly, an antioxidant is preferably incorporated in the film forming material.

It is also preferable to use an antioxidant in a suspension-washing process of cellulose ester using a poor solvent in the present invention. Any antioxidant are employable without limitation, as far as the antioxidant contained in a poor solvent inactivates radicals generated in cellulose ester, or the antioxidant restrains deterioration of cellulose ester due to oxygen added to the generated radicals.

An antioxidant utilized in the suspension-washing of cellulose ester may remain in cellulose ester after washing. The remaining amount is preferably 0.01-2,000 ppm, more preferably 0.05-1,000 ppm and furthermore preferably 0.1-100 ppm.

A compound which restrains deterioration of the material for forming a cellulose ester film due to oxygen can be utilized without limitation, as a useful antioxidant in the present invention, however, examples of a useful compound include: a phenol compound, a hindered amine compound, a phosphorus-containing compound, a sulfur-containing compound, a heat resistant processing stabilizer and an oxygen scavenger. Specifically preferable among them are a phenol compound, a hindered amine compound and a phosphorus-containing compound. By blending such a compound, it is possible to prevent coloring and strength decrease of a cellulose ester film while keeping the transparency or heat resistance of the film. These antioxidants each can be utilized alone or in combination of two types or more.

### (Phenol Compound)

A phenol type compound is a compound well known in the art and is described, for example, in columns 12-14 of U.S. Pat. No. 4,839,405 including 2,6-dialkylphenol derivative compounds. Among these compounds, examples of a preferable compound include those represented by Formula (A).

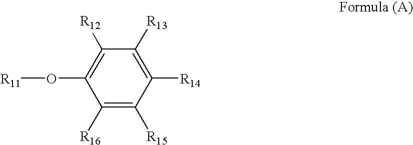

In Formula (A), R₁₁-R₁₅ each represent a substituent. Examples of the substituent include: a hydrogen atom, a halogen atom (for example, a fluorine atom and a chlorine atom), an alkyl group (for example, a methyl group, an ethyl group, an isopropyl group, a hydroxyethyl group, a methoxy methyl group, a trifluoro methyl group and a t-butyl group), a cycloalkyl group (for example, a cyclopentyl group and a cyclohexyl group), an aralkyl group (for example, a benzyl group and a 2-phenethyl group), an aryl group (for example, a phenyl group, a naphthyl group, p-tolyl group and a p-chlorophenyl group), an alkoxy group (for example, a methoxy group, an ethoxy group, an isopropoxy group and a butoxy group), an aryloxy groups (for example, a phenoxy group), a cyano group, an acylamino group (for example, an acetylamino group and a propionylamino group), an alkylthio group (for example, a methylthio group, an ethylthio group and a butylthio group), an arylthio group (for example, a phenylthio group), a sulfonylamino group (for example, a methanesulfonylamino group and a benzene sulfonyl amino group), an ureido group (for example, a 3-methylureido group, a 3,3-dimethylureido group and a 1,3-dimethylureido group), a sulfamoylamino group (for example, a dimethylsulfamoyl amino group), a carbamoyl group (for example, a methylcarbamoyl group, an ethylcarbamoyl group and a dimethylcarbamoyl group), a sulfamoyl group (for example, an ethylsulfamoyl group and a dimethylsulfamoyl group), an alkoxycarbonyl group (for example, a methoxycarbonyl group and an ethoxycarbonyl group), an aryloxycarbonyl group, (for example, a phenoxycarbonyl group), a sulfonyl group (for example, a methanesulfonyl group, a butane sulfonyl group and a phenylsulfonyl group), an acyl group (for example, an acetyl group, a propanoyl group and a butyroyl group), an amino group (for example, a methylamino group, an ethylamino group and a dimethylamino group), a cyano group, a hydroxy group, a nitro group, a nitroso group, an amine oxide group (for example, a pyridine oxide group), an imide group (for example, a phthalimide group), disulfide group (for example, a benzene disulfide group and a benzothiazolyl-2-disulfide group), a carboxyl group, a sulfo group and a heterocycle group (for example, a pyrrole group, a pyrrolidyl-group, a pyrazolyl group, an imidazolyl group, a pyridyl group, a benzimidazolyl group, a benzthiazolyl group and a benzoxazolyl group). These substituents may be further substituted.

Further, a phenol compound, in which R₁₁ is a hydrogen atom, and R₁₂ and R₁₆ each are a t-butyl group, is preferable. Examples of the phenol compound include: n-octadecyl-3-(3,5-di-t-butyl-4-hydroxyphenyl)propionate, n-octadecyl-3-(3,5-di-t-butyl-4-hydroxyphenyl)acetate, n-octadecyl-3,5-di-t-butyl-4-hydroxybenzoate, n-hexyl-3,5-di-t-butyl-4-hydroxyphenylbenzoate, n-dodecyl-3,5-di-t-butyl-4-hydroxyphenylbenzoate, neo-dodecyl-3-(3,5-di-t-butyl-4-hydroxyphenyl)propionate, dodecyl-β-(3,5-di-t-butyl-4-hydroxyphenyl)propionate, ethyl-α-(4-hydroxy-3,5-di-t-butylphenyl)isobutyrate, octadecyl-α-(4-hydroxy-3,5-di-t-butylphenyl)isobutyrate, octadecyl-α-(4-hydroxy-3,5-di-t-butyl-4-hydroxyphenyl)propionate, 2-(n-octylthio)ethyl-3,5-di-t-butyl-4-hydroxy-benzoate, 2-(n-octylthio)ethyl-3,5-di-t-butyl-4-hydroxyphenylacetate, 2-(n-octadecylthio)ethyl-3,5-di-t-butyl-4-hydroxyphenylacetate, 2-(n-octadecylthio)ethyl-3,5-di-t-butyl-4-hydroxybenzoate, 2-(2-hydroxyethylthio)-ethyl-3,5-di-t-butyl-4-hydroxybenzoate, diethylglycol-bis-(3,5-di-t-butyl-4-hydroxyphenyl)propionate, 2-(n-octadecylthio)ethyl-3-(3,5-di-t-butyl-4-hydroxyphenyl)-propionate, stearylamide-N,N-bis-[ethylene-3-(3,5-di-t-butyl-4-hydroxyphenyl)propionate], n-butylimino-N,N-bis-[ethylene-3-(3,5-di-t-butyl-4-hydroxyphenyl)propionate], 2-(2-stearoyloxyethylthio)ethyl-3,5-di-t-butyl-4-hydroxybenzoate, 2-(2-stearoyloxyethylthio)ethyl-7-(3-methyl-5-t-butyl-4-hydroxyphenyl)heptanoate, 1,2-propyleneglycol-bis-[3-(3,5-di-t-butyl-4-hydroxyphenyl)propionate], ethyleneglycol-bis-[3-(3,5-di-t-butyl-4-hydroxyphenyl)propionate], neopentylglycol-bis-[3-(3,5-di-t-butyl-4-hydroxyphenyl)propionate], ethyleneglycol-bis-(3,5-di-t-butyl-4-hydroxyphenylacetate), glycerol-l-n-octadecanoate-2,3-bis-(3,5-di-t-butyl-4-hydroxyphenylacetate), pentaerythritoltetrakis[3-(3′,5′-di-t-butyl-4′-hydroxyphenyl)propionate], 1,1,1-trimethylolethane-tris-[3-(3,5-di-t-butyl-4-hydroxyphenyl) propionate], sorbitol-hexa-[3-(3,5-di-t-butyl-4-hydroxyphenyl)propionate], 2-hydroxyethyl-7-(3-methyl-5-t-butyl-4-hydroxyphenyl)propionate, 2-stearoyloxyethyl-7-(3-methyl-5-t-butyl-4-hydroxyphenyl)heptanoate, 1,6-n-hexanediol-bis-[(3′,5′-di-butyl-4-hydroxyphenyl)propionate] and pentaerythritoltetrakis(3,5-di-t-butyl-4-hydroxyhydrocinnamate). Above phenol compounds have been commercialized, for example, as “Irganox1076” and “Irganox1010” from Ciba Specialty Chemicals, Inc.

### (Hindered Amine Compound)

In the present invention, a hindered amine compound represented by Formula (B) is preferably used as one of the useful antioxidants.

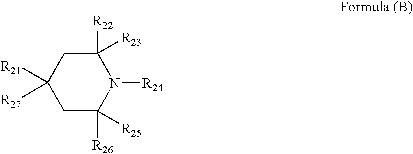

In this formula R₂₁-R₂₇ each represent a substituent. Examples of the substituent are common to the substituents R₁₁-R₁₅ described for Formula (A). R₂₄ is preferably a hydrogen atom or a methyl group, R₂₇ is preferably a hydrogen atom and R₂₂, R²³, R₂₅ and R₂₆ each are preferably a methyl group.

Examples of a hindered amine compound include: bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(N-octoxy-2,2,6,6-tetramethyl-4-piperidyl)sebacate, bis(N-benzyloxy-2,2,6,6-tetramethyl-4-piperidyl)sebacate, bis(N-cyclohexyloxy-2,2,6,6-tetramethyl-4-piperidyl)sebacate, bis(1,2,2,6,6-pentamethyl-4-piperidyl)-2-(3,5-di-t-butyl-4-hydroxybenzyl)-2-butylmalonate, bis(1-acroyl-2,2,6,6-tetramethyl-4-piperidyl)-2,2-bis(3,5-di-t-butyl-4-hydroxybenzyl)-2-butylmalonate, bis(1,2,2,6,6-pentamethyl-4-piperidyl)decanedioate, 2,2,6,6-tetramethyl-4-piperidylmethacrylate, 4-[3-(3,5-di-t-butyl-4-hydroxyphenyl) propionyloxy]-1-[2-(3-(3,5-di-t-butyl-4-hydroxyphenyl) propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propione amide, tetrakis(2,2,6,6-tetramethyl-4-piperidyl)-1,2,3,4-butanetetracarboxylate and tetrakis(1,2,2,6,6-pentamethyl-4-piperidyl)-1,2,3,4-butanetetracarboxylate.

Also, a high molecular compound may be listed, examples of which include: N,N′,N″,N′″-tetrakis[4,6-bis-[butyl(N-methyl-2,2,6,6-tetramethylpiperidine-4-yl)amino]-triazine-2-yl]-4,7-diazadecane-1,10-diamine; a polycondensation compound of dibutylamine, 1,3,5-triazine-N,N′-bis(2,2,6,6-tetramethyl-4-piperidyl)-1,6-hexamethylenediamine and N-(2,2,6,6-tetramethyl-4-piperidyl)butylamine; a polycondensation compound of dibutylamine, 1,3,5-triazine and N,N′-bis(2,2,6,6-tetramethyl-4-piperidyl)butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; a polycondensation compound of 1,6-hexanediamine-N,N′-bis(2,2,6,6-tetramethyl-4-piperidyl) and morpholine-2,4,6-trichloro-1,3,5-triazine; a high molecular weight HALS in which plurality of piperidine rings are combined via a triazine moiety, such as poly[(6-morpholino-s-triazine-2,4-diyl)[(2,2,6,6-tetramethyl-4-piperidyl)imino]-hexamethylene[(2,2,6,6-tetramethyl-4-piperidyl)imino]]; a polymer of dimethyl succinate and 4-hydroxy-2,2,6,6-tetramethyl-1-piperidineethanol; and a compound in which a piperidine ring is combined via a ester bond, such as a mixed ester compound of 1,2,3,4-butanetetracarboxylic acid, 1,2,2,6,6-pentamethyl-4-piperizinol and 3,9-bis(2-hydroxy-1,1-dimethylethyl)-2,4,8,10-tetraoxaspiro[5,5]undecane, however, the present invention is not limited thereto.

Among these compounds, preferable are, for example, a polycondensation compound of dibutylamine, 1,3,5-triazine and N,N′-bis(2,2,6,6-tetramethyl-4-piperidyl)butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; and a polymer of dimethyl succinate and 4-hydroxy-2,2,6,6-tetramethyl-1-piperidine ethanol, which have a number average molecular weight (Mn) of 2,000-5,000.

The hindered phenol based antioxidant compounds of the type listed above are commercially available as Tinuvin 144 and Tinuvin 770, manufactured by Ciba Specialty Chemicals, or as ADKSTAB LA-52 manufactured by ADEKA Corp.

### (Phosphorus-Containing Compound)

A compound having a substructure represented by Formula (C-1), (C-2), (C-3), (C-4) or (C-5) is preferably used as one of the preferable antioxidants in the present invention.

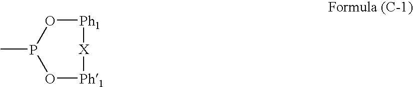

In Formula (C-1), Ph₁ and Ph′₁ each represent a substituent. Examples of the substituent are common to the substituent R₁₁-R₁₅ in the Formula (A). More preferably, Ph₁ and Ph′₁ each represent a phenylene group, and the hydrogen atom of the phenylene group may be replaced with a phenyl group, an alkyl group having 1 to 8 carbon atoms, a cycloalkyl group having 5 to 8 carbon atoms, an alkylcycloalkyl group having 6 to 12 carbon atoms, or an aralkyl group having 7 to 12 carbon atoms. Ph₁ and Ph′₁ may be mutually the same, or may be different. X represents a single bond, a sulfur atom, or a —CHR₆-group. R₆ represents a hydrogen atom, an alkyl group having 1 to 8 carbon atoms, or a cycloalkyl group having 5 to 8 carbon atoms. Further, these groups may be substituted with one of the substituents which are common to the substituents R₁₁-R₁₅ described in Formula (A).

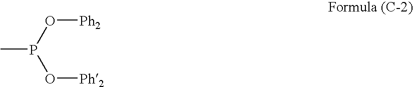

Ph₂ and Ph′₂ each represent one of the substituents which are common to the substituents R₁₁-R₁₅ described in Formula (A). Ph₂ and Ph′₂ may be mutually the same or may be different, and Ph₂ and Ph′₂ may further be substituted with one of the substituents which are common to the substituents R₁₁-R₁₅ described in Formula (A).

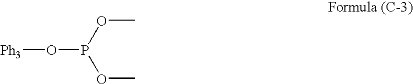

Ph₃ represents one of the substituents which are common to the substituents R₁₁-R₁₅ described in Formula (A). More preferably, Ph₃ represents a phenyl group or a biphenyl group. The hydrogen atom of the phenyl group or the biphenyl group may be replaced with an alkyl group having 1 to 8 carbon atoms, a cycloalkyl group having 5 to 8 carbon atoms, an alkylcycloalkyl group having 6 to 12 carbon atoms, or an aralkyl group having 7 to 12 carbon atoms. Ph₃ may further be substituted with one of the substituents which are common to the substituents R₁₁-R₁₅ described in Formula (A).

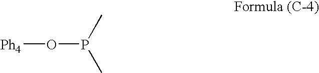

Ph₄ represents one of the substituents which are common to the substituents R₁₁-R₁₅ described in Formula (A). More preferably, Ph₄ represents an alkyl group or a phenyl group each having 1 to 20 carbon atoms. The alkyl group or the phenyl group may further be substituted with one of the substituents which are common to the substituents R₁₁-R₁₅ described in Formula (A).

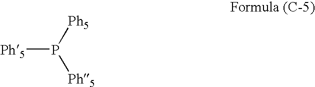

Ph₅, Ph′₅, and Ph″₅ each represent a substituent. Examples of the substituent are common to the substituents R₁₁-R₁₅ described in Formula (A). More preferably, Ph₅, Ph′₅, and Ph″₅ each represent an alkyl group having 1 to 20 carbon atoms or a phenyl group. The alkyl group or the phenyl group may further be substituted with one of the substituents which are common to the substituents R₁₁-R₁₅ described in Formula (A).

Specific examples of a phosphorus-containing compound include: mono-phosphite compounds such as triphenyl phosphite, diphenylisodecyl phosphite, phenyldiisodecyl phosphite, tris(nonylphenyl)phosphite, tris(dinonylphenyl) phosphite, tris(2,4-di-t-butylphenyl)phosphite, 10-(3,5-di-t-butyl-4-hydroxybenzyl)-9,10-dihydro-9-oxa-10-phosphaphenanthrene-10-oxide, 6-[3-(3-t-butyl-4-hydroxy-5-methylphenyl)propoxy]-2,4,8,10-tetra-t-butyldibenz[d,f][1.3.2]dioxaphosphepine and tridecyl phosphite; diphosphite compounds such as 4,4′-butylidene-bis(3-methyl-6-t-butylphenyl-di-tridecyl phosphite) and 4,4′-isopropylidene-bis(phenyl-di-alkyl (C12-C15) phosphite); phosphonite compounds such as triphenyl phosphonite, tetrakis(2,4-di-tert-butylphenyl)[1,1-biphenyl]-4,4′-diylbisphosphonite and tetrakis(2,4-di-tert-butyl-5-methylphenyl)[1,1-biphenyl]-4,4′-diylbisphosphonite; phosphinite compounds such as triphenyl phosphinite and 2,6-dimethylphenyldiphenyl phosphinite; and phosphine compounds such as triphenyl phosphine and tris(2,6-dimethoxyphenyl) phosphine.

The phosphorus-containing compound listed above have been commercialized, for example, as “Sumilizer GP” from Sumitomo Chemical Co., Ltd., “ADK STAB PEP-24G” “ADK STAB PEP-36” “ADK STAB 3010” from ADEKA Corp., “IRGAFOS P-EPQ” from Ciba Specialty Chemicals, Inc., and “GSY—P101” from SAKAI CHEMICAL INDUSTRY CO., LTD.

### (Sulfur Compound)

In this invention, a sulfur compound resented by Formula (D) is preferably used as an antioxidant.

R₃₁—S—R₃₂ Formula (D)

In the Formula (D), R₃₁ and R₃₂ each represent a hydrogen atom or a substituent. The substituent is the same as the substituents R₁₁-R₁₅ described in Formula (A).

Examples of the sulfur-containing compound include dilauryl-3,3-thiodipropionate, dimyristyl-3,3′-thiodipropionate, distearyl-3,3-thiodipropionate, lauryl stearyl-3,3-thiodipropionate, pentaerythritol-tetrakis-(β-lauryl-thiopropionate), and 3,9-bis(2-dodecylthioethyl)-2,4,8,10-tetra-oxaspiro[5,5]undecane.

The sulfur-containing compounds listed above have been commercialized, for example, as “Sumilizer TPL-R” and “Sumilizer TP-D” from Sumitomo Chemical Co., Ltd.

Similarly to the case of the aforementioned cellulose ester, the antioxidant preferably removes the impurities such as residual acid, inorganic salt and organic low-molecule compound that have been carried over from the process of manufacturing, or that have occurred during preservation. More preferable is to have a purity of 99% or more. The amount of residual acid and water is preferably 0.01 through 100 ppm. This reduces thermal deterioration in the melt-casting film formation of the cellulose ester, and improves the film formation stability, the optical property and the mechanical property of the film.

The anti-oxidants may be used one or more species in combination in each, and its content in the cellulose ester film is ordinarily from 0.01 to 10.0 parts by weight, preferably from 0.1 to 5.0 parts by weight, and more preferably 0.2 to 2 parts by weight. Two or more compounds may be used together.

It is not preferable, when the amount of the anti-oxidant is too small, effect is not obtained because of low stabilizing work, and when the amount of the anti-oxidant is too small, deterioration of transparency is induced in view of compatibility to cellulose ester and the film becomes fragile.

### (Acid Scavengers)

It is preferable to incorporate an acid scavenger as a stabilizing agent in the optical film of this invention, since decomposition of the cellulose ester is accelerated by also acid under high temperature environment such as melt-casting. Any compounds may be employed without restriction as a useful acid scavenger in this invention as far as the compounds reacts with an acid to make the acid inactive. Preferable examples thereof include compounds containing an epoxy group described in U.S. Pat. No. 4,137,201. The epoxy compounds which are acid scavengers are known in the technological field, and examples include polyglycols derived by condensation such as diglycidyl ethers of various polygycols, especially those having approximately 8-40 moles of ethylene oxide per mole of polyglycol, diglycidyl ethers of glycerol; metal epoxy compounds (such as those used in the past in vinyl chloride polymer compositions and those used together with vinyl chloride polymer compositions), epoxy ether condensation products, a diglycidyl ether of Bisphenol A (namely 4,4′-dihydroxydiphenyl dimethyl methane), epoxy unsaturated fatty acid esters (particularly alkyl esters having about 4-2 carbon atoms of fatty acids having 2-22 carbon atoms (such as butyl epoxy stearate); and various epoxy long-chain fatty acid triglycerides; (such as epoxy plant oils which are typically compositions of epoxy soy bean oil; and other unsaturated natural oils (these are sometimes called epoxidized natural glycerides or unsaturated fatty acids and these fatty acids generally have 12 to 22 carbon atoms)). Particularly preferable are commercially available epoxy resin compounds, which include an epoxy group such as EPON 815c, and other epoxidized ether oligomer condensates such as those represented by the general formula (E).

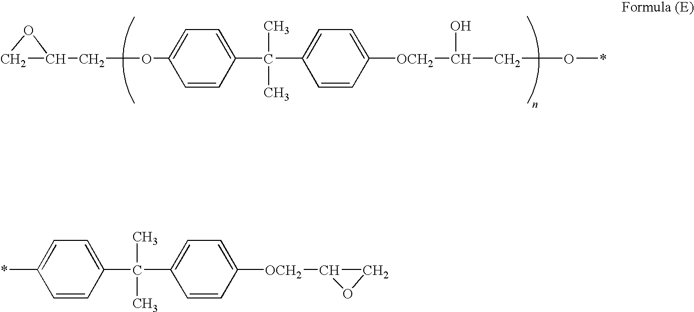

In the formula n is an integer of 0-12. Other examples of acid scavengers that can be used include those described in paragraphs 87-105 in JP-A H05-194788.

The adding amount of the acid scavenger is 0.1-10% by weight, preferably 0.2-5, and more preferably 0.5-2% by weight. Two or more kinds of the acid scavenger may be used in combination.

An acid scavenger is also referred to as an acid capture, an acid scavenger, an acid catcher, however, in the present invention, any of these agents are usable regardless of the difference in the terms.

### (Ultraviolet Absorbent)

The ultraviolet absorbent preferably has excellent ultraviolet light absorbance for wavelengths not greater than 370 nm in view of preventing deterioration of the polarizer or the display device due to ultraviolet light, and from the viewpoint of the liquid crystal display it is preferable that there is little absorbance of visible light which has wavelength of not less than 400 nm. Examples of the ultraviolet absorbents include oxybenzophenone compounds, benzotriazole compounds, salicylic acid ester compounds, benzophenone compounds, cyano acrylate compounds, nickel complex compounds, triazine compounds; and benzophenone compounds as well as benzotriazole compounds and triazine compounds which have little coloration are preferable. In addition, the ultraviolet absorbents described in JP-A Nos. H10-182621 and H08-337574, and the high molecular ultraviolet absorbents described in JP-A H06-148430 and JP-A 2003-113317 may also be used.

Examples of useful benzotriazole based ultraviolet absorbents include 2-(2′-hydroxy-5′-methylphenyl)benzotriazole, 2-(2′-hydroxy-3′,5′-di-tert-butyl phenyl)benzotriazole, 2-(2′-hydroxy-3′-tert-butyl-5′-methylphenyl)benzotriazole, 2-(2′-hydroxy-3′,5′-di-tert-butyl phenyl)-5-chlorobenzotriazole, 2-(2′-hydroxy-3′-(3″, 4″, 5″, 6″-tetrahydrophthalimide methyl)-5′-methylphenyl)benzotriazole, 2,2-methylene bis(4-(1,1,3,3-tetramethyl butyl)-6-(2H-benzotriazole-2-yl)phenol), 2-(2′-hydroxy-3′-tert-butyl-5′-methylphenyl)-5-chlorobenzotriazole, 2-(2′-hydroxy-3′-tert-butyl-5′-(2-octyloxycarbonylethyl)-phenyl)-5-chloro benzotriazole, 2-(2′-hydroxy-3′-(1-methyl-lphenylethyl)-5′-(1,1,3,3-tetramethylbutyl)-phenyl)benzotriazole, 2-(2H-benzotriazole-2-yl)-6-(straight chain or side chain dodecyl)-4-methylphenol, a mixture of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate, and so on. It is not limited to these examples.

Commercially available TINUVIN 171, TINUVIN 900, TINUVIN 928 and TINUVIN 360, (each being manufactured by Chiba Specialty Chemical Co., Ltd.), LA-31 (manufactured by Asahi Denka, Co., Ltd.), and RUVA-100 (manufactured by Otsuka Chemical Co., Ltd.) may also be used.

Examples of the benzophenone based compound include 2,4-dihydroxy benzophenone, 2,2′-dihydroxy-4-methoxy benzophenone, 2-hydroxy-4-methoxy-5-sulfobenzophenone, bis (2-methoxy-4-hydroxy-5-benzoyl phenyl methane); but are not limited thereto.

The amount of the ultraviolet absorbent to add in the cellulose ester film is preferably from 0.1 to 5% by weight, more preferably from 0.2 to 3% by weight, and still more preferably from 0.5 to 2% by weight. Two or more kinds of the ultraviolet absorbents may be used together.

The benztriazole structure or triazine structure may compose a part of a polymer or pendant regularly on a polymer, or may be introduced into a part of molecular structure of an additive such as a plasticizer, an anti-oxidant, an acid scavenger.

The conventional ultraviolet absorbing polymer is not specifically limited, but there is, for example, a homopolymer obtained by polymerization of RUVA-93 (produced by Otsuka Chemical Co., Ltd.) and a copolymer obtained by copolymerization of RUVA-93 and another monomer. Typical examples of the ultraviolet absorbing polymer include PUVA-30M obtained by copolymerization RUVA 93 and methyl:methacrylate (3:7 by weight ratio), PUVA-50M obtained by copolymerization RUVA 93 and methyl methacrylate (5:5 by weight ratio), and ultraviolet absorbing polymers disclosed in JP A No. 2003-113317.

### (Plasticizer)

It is preferable to incorporate at least one plasticizer to a film forming material in the process of the optical film of the present invention.

The plasticizers are additives having a function improving flexibility and imparting flexibility. The plasticizer is added to reduce the melting temperature of the materials composing the film to be lower than the respective melting temperature of the cellulose ester used in the cellulose ester of the preferable example of this invention. Also, at the same heating temperature, the viscosity of the materials composing the film including the plasticizer can be reduced to be less than that of the cellulose ester. The plasticizer is added to improve hydrophilic property and vapor permeability of the cellulose ester, and therefore has a function of preventing vapor permeability.

In this invention, the melting temperature for the materials composing the film refers to the temperature at which the materials become liquid having fluidity when the materials are heated. It is required to heat the cellulose ester at lowest glass transition temperature point to make it melt and fluidize. Coefficient or viscosity will be lowered by thermal absorption and fluidity displays at a temperature of higher than glass transition temperature. However, cellulose ester should be melt as low temperature as possible since molecular weight of cellulose ester reduces by thermal decomposition simultaneously melting at high temperature, resulting unfavorable affects to mechanical strength of film to be obtained. It is possible to make lower the melting point of the film composing materials by adding a plasticizer having a melting point or glass transition point lower than the glass transition point of cellulose ester.

The cellulose ester film according to this invention is featured by containing a plasticizer preferably in an amount of 1-25% by weight. It is not preferable as improvement of flatness is not insufficient when less than 1% by weight, and bleed out is apt to occur and aged deterioration of stability of film when more than 25% by weight. It is more preferable to contain 5-15% by weight.

Further, it is preferable that the ester based plasticizer formed from polyhydric alcohol and a monohydric carboxylic acid and the ester based plasticizer formed from a polyhydric carboxylic acid and a monohydric alcohol have a high affinity for the cellulose ester.

Examples of preferred polyhydric alcohols include, but are not limited to, adonitol, arabitol, ethyleneglycol, glycerin, diglycerin, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, ditrimethylolpropane, trimethylolethane, pentaerythritol, dipentaerythritol, and xylitol. Particularly preferred are ethyleneglycol, glycerin, and trimethylolpropane.

Specific examples of an ethylene glycol ester based plasticizer of a polyhydric ester based plasticizer include; ethylene glycol alkyl ester based plasticizers such as ethylene glycol diacetate, ethylene glycol dibutyrate; ethylene glycol cycloalkyl ester based plasticizers such as ethylene glycol dicyclopropyl carboxylate, and ethylene glycol dicyclohexyl carboxylate; and ethylene glycol aryl ester based plasticizers such as ethylene glycol dibenzoate, and ethylene glycol di-4-methyl benzoate. These alkylate groups, cycloalkylate groups and arylate groups may be the same or different and may further be substituted. The substituent groups may be a mixture of alkylate groups, cycloalkylate groups and arylate groups, and the substituent groups may be bonded to each other by covalent linkage.

Further, the ethylene glycol part may be substituted and the ethylene glycol ester part of the structure may be part of the polymer or may be regularly included as a pendant. It may also be introduced into a part of the molecular structure of the additive such as an antioxidant, an acid scavenger, and an ultraviolet light absorber.

Examples of a glycerin ester based plasticizer, which is a polyhydric alcohol ester based plasticizer, include glycerin alkyl esters such as triacetin, tributyrin, glycerin diacetate carboxylate, and glycerin oleate propionate; glycerin cycloalkyl esters such as glycerin tricyclopropyl carboxylate, and glycerin tricyclohexyl carboxylate; glycerin aryl esters such as glycerin tribenzoate, and glycerin-4-methylbenzoate; diglycerin alkyl esters such as diglycerin tetraacetylate, diglycerin tetrapropionate, diglycerin acetate tricaprylate, and diglycerin tetralaurate; diglycerin cycloalkyl esters such as diglycerin tetracyclobutyl carboxylate, and diglycerin tetracyclopentyl carboxylate; and diglycerin aryl esters such as diglycerin tetrabenzoate, and diglycerin-3-methyl benzoate. These alkylate groups, cycloalkyl carboxylate groups and arylate groups may be same or different and may further be substituted. The substituent groups may be a mix of alkylate groups, cycloalkyl carboxylate groups and arylate groups, and the substituent groups may be bonded to each other by covalent bonds. Further, the glycerin and diglycerin portions may be substituted and the glycerin ester or diglycerin ester part of the structure may be a part of the polymer or may be regularly included as a pendant. It may also be introduced into a part of the molecular structure of the additive such as an antioxidant, an acid scavenger, and an ultraviolet light absorber.

Other examples of other polyhydric alcohol ester based plasticizers are given in JP-A 2003-12823 from paragraphs 30-33.

These alkylate groups, cycloalkyl carboxylate groups and arylate groups may be same or different and may be further substituted. The alkylate groups, cycloalkyl carboxylate groups and arylate groups may be mixed, and the substituent groups may be bonded to each other by covalent bonds. Furthermore, the polyhydric alcohol portion may be substituted and polyhydric alcohol part of the structure may be a part of the polymer or may be systematically included as a pendant. It may also be introduced into a part of the molecular structure of the additive such as the antioxidant, the acid scavenger the ultraviolet light absorber.

Of the ester based plasticizers formed from a polyhydric alcohol and a monohydric carboxylic acid, alkyl polyhydric alcohol aryl esters are preferable; specific examples include ethylene glycol benzoate, glycerin tribenzoate, diglycerin tetrabenzoate and compound 16 which is given as an example in paragraph 31 of JP-A 2003-12823.

Specific examples of the dicarboxylic acid ester based plasticizer which is a polyhydric carboxylic acid ester based plasticizer include alkyl dicarboxylic acid alkyl ester based plasticizers such as didodecyl malonate, dioctyl adipate and dibutyl sebacate; alkyl dicarboxylic acid cycloalkyl ester based plasticizers such as dicyclopentyl succinate and dicyclohexyl adipate; alkyl dicarboxylic acid aryl ester based plasticizers such as diphenyl succinate and di-4-methyl phenyl glutarate, cycloalkyl dicarboxylic acid alkyl ester based plasticizers such as dihexyl-1,4-cyclohexane dicarboxylate and didecyl bicyclo[2.2.1]heptane-2,3-dicarboxylate; cycloalkyl dicarboxylic acid cycloalkyl ester based plasticizers such as dicyclohexyl-1,2-cyclobutane dicarboxylate and dicyclopropyl-1,2-cyclohexyl dicarboxylate; cycloalkyl dicarboxylic acid aryl ester based plasticizers such as diphenyl-1,1-cyclopropyl dicarboxylate and di-2-naphtyl-1,4-cyclohexane dicarboxylate; aryl dicarboxylic acid alkyl ester based plasticizers such as diethyl phthalate, dimethyl phthalate, dioctyl phthalate, dibutyl phthalate and di-2-ethylhexyl phthalate; aryl dicarboxylic acid cycloalkyl ester based plasticizers such as dicyclopropyl phthalate and dicyclohexyl phthalate; and aryl dicarboxylic acid aryl ester based plasticizers such as diphenyl phthalate and di-4-methyl phenyl phthalate. These alkoxy groups and cycloalkoxy groups may be the same or different, and may also be substituted and the substitution groups may be further substituted. The alkyl groups and the cycloalkyl groups may be mixed, and the substituent groups may be bonded to each other by covalent bonds. Furthermore, the aromatic ring of the phthalic acid may be substituted and may be polymer such as a dimer, trimer, tetramer. The phthalic acid ester part of the structure may be a part of the polymer or may be systematically included as a pendant. It may also be introduced into a part of the molecular structure of the additive such as an antioxidant, an acid scavenger and an ultraviolet light absorber.

Specific examples of other polyhydric carboxylic acid ester plasticizers include alkyl polyhydric carboxylic acid alkyl ester based plasticizers such as tridodecyl tricarbalate and tributyl-meso-butane-1,2,3,4-tetracarboxylate; alkyl polyhydric carboxylic acid cycloalkyl ester based plasticizers such as tricyclohexyl tricarbalate, and tricyclopopyl-2-hydroxy-1,2,3-propane tricarboxylate; alkyl polyhydric carboxylic acid aryl ester based plasticizers such as triphenyl-2-hydroxyl-1,2,3-propane tricarboxylate and tetra-3-methyl phenyl tetrahydrofuran-2,3,4,5-tetracarboxylate; cycloalkyl polyhydric carboxylic acid alkyl ester based plasticizers such as tetrahexyl-1,2,3,4-cyclobutane tetracarboxylate and tetrabutyl 1,2,3,4-cyclopentane tetracarboxylate; cycloalkyl polyhydric carboxylic acid cycloalkyl ester based plasticizers such as tetracyclopropyl-1,2,3,4-cyclobutane tetracarboxylate and tricyclohexyl-1,3,5-cyclohexyl tricarboxylate; cycloalkyl polyhydric carboxylic acid aryl ester based plasticizers such as triphenyl-1,3,5-cyclohexyl tricarboxylate and hexa 4-methyl phenyl-1,2,3,4,5,6-cyclohexyl hexacarboxylate; aryl polyhydric carboxylic acid alkyl ester based plasticizers such as tridodecyl benzene-1,2,4-tricarboxylate and tetraoctyl benzene-1,2,4,5 tetracarboxylate; aryl polyhydric carboxylic acid cycloalkyl ester based plasticizers such as tricyclopentyl benzene-1,3,5-tricarboxylate and tetracyclohexyl benzene-1,2,3,5-tetracarboxylate; and aryl polyhydric carboxylic acid aryl ester based plasticizers such as triphenyl benzene-1,3,5-tetracarboxylate and hexa 4-methylphenyl benzene-1,2,3,4,5,6-hexacarboxylate. These alkoxy groups and cycloalkoxy groups may be the same or different, and may also be substituted and the substitution groups may be further substituted. The alkyl groups and the cycloalkyl groups may be mixed, and the substituent groups may be bonded to each other by covalent bonds. Furthermore, the aromatic ring of the phthalic acid may be substituted and may be a polymer such as a dimer, trimer, tetramer and the like. The phthalic acid ester part of the structure may be a part of the polymer or may be systematically included as a pendant. It may also be introduced into a part of the molecular structure of the additive such as the antioxidant, the acid scavenger the ultraviolet light absorber and the like.

Of the ester based plasticizers formed from a polyhydric carboxylic acid and a monohydric alcohol, alkyl dicarboxylic acid alkyl esters are preferable, specifically the foregoing dioctyl adipate.

Other plasticizers that can be used in this invention include phosphoric acid ester based plasticizers, carboxylate ester based plasticizers, polymer plasticizers and the like.

Specific examples of the phosphoric acid ester based plasticizer include phosphoric acid alkyl esters such as triacetyl phosphate and tributyl phosphate; phosphoric acid cycloalkyl esters such as tricyclopentyl phosphate and cyclohexyl phosphate; phosphoric acid aryl esters such as triphenyl phosphate, tricresyl phosphate, cresylphenyl phosphate, octyldiphenyl phosphate, diphenylbiphenyl phosphate, trioctyl phosphate, tributyl phosphate, trinaphthyl phosphate, triglyceryl phosphate, tris ortho-biphenyl phosphate. The substituent groups for these may be the same or different, and may be further substituted. The substituent groups may be a mixture of alkyl groups, cycloalkyl groups and aryl groups, and the substituent groups may be bonded to each other by covalent bonds.

Examples of the phosphoric acid ester also include alkylene bis(dialkyl phosphates) such as ethylene bis(dimethyl phosphate), butylene bis(diethyl phosphate); alkylene bis(diaryl phosphates) such as ethylene bis(diphenyl phosphate), propylene bis(dinaphthyl phosphate); arylene bis(dialkyl phosphates) such as phenylene bis(dibutyl phosphate), biphenylene bis(dioctyl phosphate); and arylene bis(diaryl phosphates) such as phenylene bis(diphenyl phosphate), naphthylene bis(ditoluoyl phosphate). These substituent groups may the same or different, and may be further substituted. The substituent groups may be a mixture of an alkyl group, cycloalkyl groups and aryl groups, and the substituent groups may be bonded to each other by covalent bonds.

Furthermore, a part of the structure of the phosphoric acid ester may be a part of the polymer or may be systematically included as a pendant. It may also be introduced into a part of the molecular structure of the additive such as the antioxidant, the acid scavenger, the ultraviolet light absorber and the like. Of the compounds listed above, aryl ester phosphates and arylene bis(diaryl phosphates) are preferable, and more specifically, triphenyl phosphate and phenylene bis(diphenyl phosphate) are preferable.

A carbohydrate ester type plasticizer will now be described. Carbohydrate means monosaccharide, disaccharide or trisaccharide in which saccharide is present in a state of pyranose or furanose (6-member ring or 5-member ring). Unlimited examples of carbohydrate include glucose, saccharose, lactose, cellobiose, mannose, xylose, ribose, galactose, arabinose, fructose, sorbose, cellotriose and raf finose. Carbohydrate ester indicates those, in which a hydroxyl group of carbohydrate and carboxylic acid are dehydration condensed to form an ester compound, and, more specifically, indicates an aliphatic carboxylic ester or an aromatic carboxylic ester. Aliphatic carboxylic acid includes such as acetic acid and propionic acid, and aromatic carboxylic acid includes such as benzoic acid, toluic acid and anisic acid. Carbohydrate is provided with hydroxyl groups of corresponding number to the type, however, either a part of hydroxyl group and carboxylic acid may react to form an ester compound or the whole hydroxyl group and carboxylic acid react to form an ester compound. It is preferable that the whole hydroxyl group and carboxylic acid react to form an ester compound in the present invention.

Specific examples of carbohydrate ester type plasticizer preferably include such as glucose pentaacetate, glucose pentapropionate, glucose pentabutyrate, saccharose octaacetate and saccharose octabenzoate. Saccharose octaacetate and saccharose octabenzoate are more preferable among them, and saccharose octabenzoate is particularly preferable.

Examples of these compounds are listed below, but not limitative.

MONOPET SB, manufactured by Dai-Ichi Seiyaku Kogyo Co., Ltd.

MONOPET SOA, manufactured by Dai-Ichi Seiyaku Kogyo Co., Ltd.

The polymer plasticizer includes, for example, aliphatic hydrocarbon type polymer; alicyclic hydrocarbon type polymer; acryl type polymer such as polyethyl acrylate, polymethyl methacrylate, and copolymer of methylmethacrylate and 2-hydroxyethylmethacrylate (for example, an arbitrary copolymerization ratio in a range of 1:99-99:1); vinyl type polymer such as polyvinyl isobutyl ether and poly-N-vinyl pyrrolidone; styrene type polymer such as polystyrene and poly-4-hydroxystyrene; polyester such as polybutylene succinate, polyethylene terephthalate, and polyethylenenaphthalate, polyether such as polyethyleneoxide and polypropyleneoxide; polyamide; polyurethane and polyurea.

The number average molecular weight of a polymer plasticizer is preferably 1,000-500,000 and specifically preferably 5,000-200,000. The number average molecular weight of less than 1,000 may cause a problem of volatility and that of more than 500,000 may result in lowering of plasticizing ability which may cause an unfavorable effect on the physical property of the cellulose ester film. These polymer plasticizers may be a homopolymer containing a single kind of repeat unit or a copolymer containing plural kinds of repeat units, or may contain two or more of the above polymers.

Other plasticizers described above are added in an amount of usually 0.1-50 parts, preferably 1-30 parts, and more preferably 3-15 parts by weight based on 100 parts by weight of cellulose ester.

The cellulose ester film of the present invention preferably contains 1-25% by weight of an ester type plasticizer composed of polyalcohol and monovalent carboxylic acid or an ester type plasticizer composed of polycarboxylic acid and monoalcohol. These may be used with other plasticizer in combination.

The ester type plasticizer composed of polyalcohol and monocarboxylic acid, and the ester type plasticizer composed of three or more valent polyalcohol and monocarboxylic acid are most preferable, since they have high compatibility with cellulose ester and they may be added in large amount, other plasticizers or other additives may be easily used with these plasticizers as generation of bleed out is minimized.

The optical film of this invention is preferably has Yellow Index (YI) of not more than 3.0, more preferably not more than 1.0, because it is not advantageously affected to the optical usage as it is colored. Yellow Index can be measured according to JIS K7103.

### (Matting Agent)

A matting agent may be added to the cellulose ester film of the invention in order to impart lubricity, and optical and mechanical function. The matting agent includes fine particles of inorganic compounds as well as fine particles of organic compounds may be used.

The matting agent having shape of sphere, rod, needle, lamellar, or tabular is preferably employed. The matting agent includes inorganic fine particles such as oxide, phosphate, silicate, carboxylate of metal, and the like, including silicon dioxide, titanium dioxide, aluminum oxide, zirconium oxide, calcium carbonate, kaolin, talc, burned calcium silicate, hydrated calcium silicate, aluminum silicate, magnesium silicate, and calcium phosphate, or fine particles of cross-linked high molecular compounds. Of these, silicon dioxide is preferable in view of reduced haze in the film. These particles surface treated with an organic substance are preferable because they reduce haze in the film.

The surface treatment is preferably conducted using halosilanes, alkoxysilanes, silazanes, and siloxanes. Particles having a larger average particle diameter have a greater matting effect, while particles having a smaller average particle diameter have excellent transparency. The primary particles have an average particle diameter of 0.01 to 1.0 μm. The primary particles preferably have an average particle diameter in the range of 5 to 50 nm, and more preferably 7 to 14 nm. These fine particles are preferable because they create unevenness of 0.01 to 1.0 μm in the plane of the cellulose ester film.

Examples of the silicon dioxide particles include Aerosil 200, 200V, 300, R972, R972V, R974, R202, R812, OX50, TT600, and NAX50, each manufactured by Nippon Aerosil Co., Ltd., and KE-P10, KE-P30, KE-P100, and KE-P100 each manufactured by Nippon Shokubai Co., Ltd., and of these, Aerosil 200V, R972V, NAX50, KE-P30, and KE-P100 are preferred. Two or more of these matting agents may be combined and used. In the case where 2 or more matting agents are used, they may be mixed in a suitably selected proportion.

In this case using two or more kinds, matting agents which have different particle diameter and quality such as Aerosil 200V and R972V may be used in weight proportions in the range from 0.1:99.9-99.9:0.1

These matting agents are preferably added by kneading. Or, alternatively, the matting agent is added during the production process of a melt of cellulose ester by using a solid which is prepared in the following method; dispersing previously dispersing a matting agent in a solvent and resin and/or a plasticizer and/or an anti-oxidant and/or a UV absorbent, and separating the solid content by evaporating the solvent or by precipitation of the solid content. The latter method is preferable because the matting agent can be more uniformly dispersed in the cellulose ester.

The above matting agent may also be used in order to improve a mechanical property, an electric property or an optical property of the film.

The addition of more amount of matting agent into the film for a display of the present invention results in improving the lubricant property of the film, however, haze of the film also increases. Accordingly, the content of a matting agent in the film is preferably 0.001-5 weight %, more preferably 0.005-1 weight %, and still more preferably 0.01-0.5 weight %, based on the weight of cellulose ester.

The haze value of the film for a display of the present invention is preferably less than 1.0%, but is more preferably less than 0.5%, since the haze of 1% or more may affect the optical property of the film. The haze value is determined according to the method of JIS K 7136.

The film constituting material is required to generate very small amount of volatile matter or no volatile matter at all in the melting and film formation process. This is intended to ensure that the foaming occurs at the time of heating and melting to remove or avoid the defect inside the film and poor flatness on the film surface.

When the film constituting material is molten, the amount of the volatile matter contained is 1% by mass or less, preferably 0.5% by mass or less, more preferably 0.2% by mass or less, still more preferably 0.1% by mass or less. A differential thermogravimetric apparatus (differential weight calorimetry (TG/DTA 200 by Seiko Instruments Inc.) is used to get a weight loss on heating from 30° C. through 250° C. The result is used as the amount of the volatile matter contained in the present invention.

The moisture and the volatile components represented the aforementioned solvent are preferably removed from the film constituting material to be used before film formation or at the time of heating. They can be removed by the conventional method. A heating method, depressurization method, or heating/depressurization method can be used to remove them in air or in nitrogen atmosphere as an inert gas atmosphere. When the known drying method is used, this procedure is carried out in the temperature range wherein the film constituting material is not decomposed. This is preferred to ensure good film quality.

Generation of the volatile components can be reduced by the drying step prior to film formation. It is possible to dry the resin independently, or dry the resin and film constituting materials by separating into a mixture or compatible substances made of at least one or more types other than the resin. The drying temperature is preferably 70° C. or more. If the material to be dried contains any substance having a glass-transition temperature, and is heated up to a drying temperature higher than that glass-transition temperature, the material will be fused and will become difficult to handle. To avoid this, the drying temperature is preferably kept at a level not exceeding the glass-transition temperature. If a plurality of substances has a glass-transition temperature, the glass-transition temperature of the substance having a lower glass-transition temperature should be used as a standard. This temperature is preferably 70° C. or more through (glass-transition temperature—5)° C. or less, more preferably 110° C. or more through (glass-transition temperature −20)° C. or less. The drying time is preferably 0.5 through 24 hours, more preferably 1 through 18 hours, still more preferably 1.5 through 12 hours. If the drying temperature is too low, the rate of removing the volatile components will be reduced and much time will be required for drying. The drying process can be divided into two or more steps. For example, the drying process may includes a pre-drying step for storing the material, and a preliminary drying step for the period one week before film formation through the period immediately before film formation.

### <Melt Casting Method>

The optical film composed of the cellulose ester film of the present invention is preferably formed by melt casting of the cellulose ester as mentioned above. The molding method by melt casting wherein heating and melting are conducted without using the solvent which is used in the solution casting method (e.g., methylene chloride) can be divided into categories of a melt-extrusion molding method, press molding method, inflation method, injection molding method, blow molding method, draw molding method, and others. Of these methods, melt-extrusion molding method is preferred to produce a polarizing plate protective film characterized by excellent mechanical strength and surface accuracy.

The following describes the film manufacturing method of the present invention with reference to the melt extrusion method.

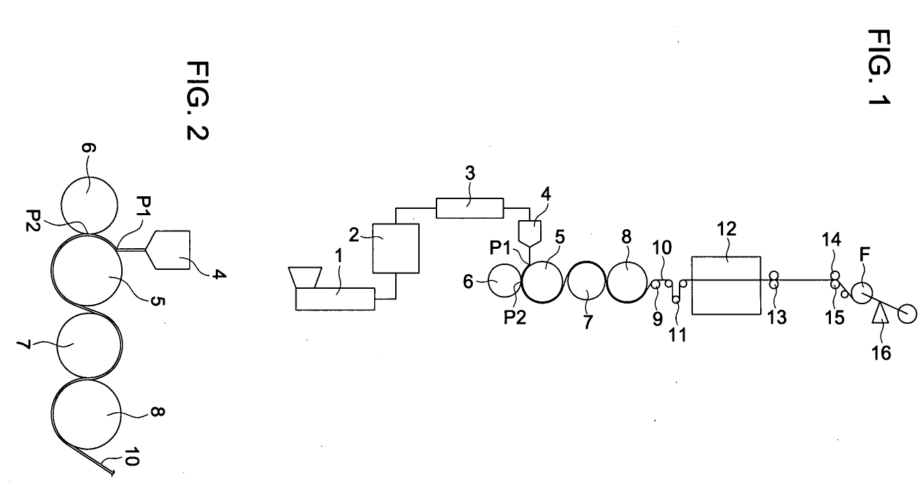

FIG. 1 is a schematic flow sheet showing the overall structure of the apparatus for practicing the cellulose ester film manufacturing method of the present invention. FIG. 2 is an enlarged view of the cooling roll portion from the flow casting die.

In the cellulose ester film manufacturing method shown in FIG. 1 and FIG. 2, the film material such as cellulose resin is mixed, then melt extrusion is conducted on a first cooling roll 5 from the flow casting die 4 using the extruder 1. The material is circumscribed on a first cooling roll 5, second cooling roll 7 and third cooling roll 8—a total of three cooling rolls—sequentially. Thus, the material is cooled, solidified and formed into a film 10. With both sides gripped by a stretching apparatus 12, the film 10 separated by a separation roll 9 is stretched across the width and is wound by a winding apparatus 16. To correct flatness, a touch roll 6 is provided. This is used to press the film against the surface of the first cooling roll 5. This touch roll 6 has an elastic surface and forms a nip with the first cooling roll 5. The details of the touch roll 6 will be described later.

The conditions for the cellulose ester film manufacturing method are the same as those for thermoplastic resins such as other polyesters. The material is preferably dried in advance. A vacuum or depressurized dryer, or dehumidified hot air dryer is used to dry the material until the moisture is reduced to 1000 ppm or less, preferably 200 ppm or less.

For example, the cellulose ester based resin having been dried under hot air, vacuum or depressurized atmosphere is extruded by the extruder 1 and is molten at a temperature of about 200-300° C. The leaf disk filter 2 is used to filter the material to remove foreign substances.

When the material is fed from the feed hopper (not illustrated) to the extruder 1, the material is preferably placed in the vacuum, depressurized or insert gas atmosphere to prevent oxidation and decomposition.

When additives such as plasticizer are not mixed in advance, they can be kneaded into the material during the process of extrusion. To ensure uniform mixing, a mixer such as a static mixer 3 is preferably utilized.

In the present invention, the cellulose resin and the additives such as a stabilizer to be added as required are preferably mixed before being molten. It is more preferred that the cellulose resin and additives should be mixed prior to heating. A mixer may be used for mixing. Alternatively, mixing may be completed in the process of preparing the cellulose resin, as described above. A general mixer can be used such as a V-type mixer, conical screw type mixer, horizontal cylindrical type mixer, Henschel mixer and ribbon mixer.

As described above, subsequent to mixing of the film constituting material, the mixture can be directly molten by the extruder 1 to form a film. Alternatively, it is also possible to palletize the film constituting material, and the resultant pellets may be molten by the extruder 1, whereby a film is formed. The following arrangement can also be used. When the film constituting material contains a plurality of materials having different melting points, so-called patchy half-melts are produced at the temperature wherein only the material having a lower melting point is molten. The half-melts are put into the extruder 1, whereby a film is formed. Further, the following arrangement can also be used. If the film constituting material contains the material vulnerable thermal decomposition, a film is directly formed without producing pellets, thereby reducing the frequency of melting. Alternatively, a film is produced after patchy half-melts have been formed, as described above.

Various types of commercially available extruders can be used as the extruder 1. A melt-knead extruder is preferably utilized. Either a single-screw extruder or a twin-screw extruder can be used. When producing a film directly without pellets being formed from the film constituting material, an adequate degree of mixing is essential. In this sense, a twin-screw extruder is preferably used. A single-screw extruder can be used if the screw is changed into a kneading type screw such as a Madoc screw, Unimelt screw or Dulmage screw, because a proper degree of mixing can be obtained by this modification. When pellets or patchy half-melts are used as film constituting materials, both the single screw extruder and twin screw extruder can be used.

In the cooling process inside the extruder 1 and after extrusion, oxygen density is preferably reduced by an inert gas such as nitrogen gas or by depressurization.

The preferred conditions for the melting temperature of the film constituting material inside the extruder 1 vary according to the viscosity and discharge rate of the film constituting material as well as the thickness of the sheet to be produced. Generally, it is Tg or more through Tg+100° C. or less with respect to the glass-transition temperature Tg of the film, preferably Tg+10° C. or more through Tg+90° C. or less. The melt viscosity at the time of extrusion is 10 through 100,000 poises, preferably 100 through 10,000 poises. The retention time of the film constituting material inside the extruder 1 should be as short as possible. It is within 5 minutes, preferably within 3 minutes, more preferably within 2 minutes. The retention time varies according to the type of the extruder and the conditions for extrusion. It can be reduced by adjusting the amount of the material to be supplied, the L/D, the speed of screw and the depth of screw groove.

The shape and speed of the screw of the extruder 1 are adequately selected in response to the viscosity and discharge rate of the film constituting material. In the present invention, the shear rate of the extruder 1 is 1/sec. to 10,000/sec., preferably 5/sec. to 1,000/sec., more preferably 10/sec. to 100/sec.

The extruder 1 that can be used in the present invention can be obtained as a plastic molding machine generally available on the market.

The film constituting material extruded from the extruder 1 is fed to the flow casting die 4, and the slit of the flow casting die 4 is extruded as a film. There is no restriction to the flow casting die 4 if it can be used to manufacture a sheet or film. The material of the flow casting die 4 are exemplified by hard chromium, chromium carbide, chromium nitride, titanium carbide, titanium carbon nitride, titanium nitride, hard metal, ceramic (tungsten carbide, aluminum oxide, chromium oxide), which are flame sprayed or plated. Then they are subjected to surface processing, as exemplified by buffing and lapping by a grinder having a count of #1000 or later planar cutting (in the direction perpendicular to the resin flow) by a diamond wheel having a count of #1000 or more, electrolytic grinding, and electrolytic complex grinding. The preferred material of the lip of the flow casting die 4 is the same as that of the flow casting die 4. The surface accuracy of the lip is preferably 0.5 S or less, more preferably 0.2 S or less.

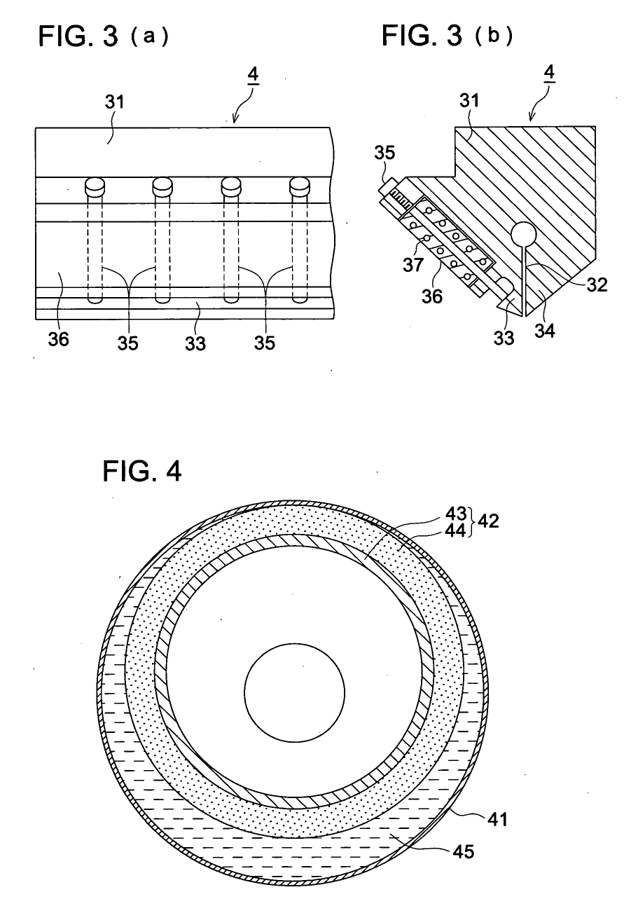

The slit of this flow casting die 4 is designed in such a way that the gap can be adjusted. This is shown in FIG. 3. Of a pair of lips forming the slit 32 of the flow casting die 4, one is the flexible lip 33 of lower rigidity easily to be deformed, and the other is a stationary lip 34. Many heat bolts 35 are arranged at a predetermined pitch across the flow casting die 4, namely, along the length of the slit 32. Each heat bolt 5 includes a block 36 containing a recessed type electric heater 37 and a cooling medium passage. Each heat bolt 35 penetrates the block 36 in the vertical direction. The base of the heat bolt 35 is fixed on the die (main body) 31, and the front end is held in engagement with the outer surface of the flexible lip 33. While the block 36 is constantly cooled, the input of the recessed type electric heater 37 is adjusted to increase or decrease the temperature of the block 36, this adjustment causes thermal extension and contraction of the heat bolt 35, and hence, displacement of the flexible lip 33, whereby the film thickness is adjusted. The following arrangement can also be used: A thickness gauge is provided at predetermined positions in the wake of the die. The web thickness information detected by this gauge is fed back to the control apparatus. This thickness information is compared with the preset thickness information of the control apparatus, whereby the power of the heat generating member of the heat bolt or the ON-rate thereof is controlled by the signal for correction control amount sent from this apparatus. The heat bolt preferably has a length of 20 through 40 cm, and a diameter of 7 to 14 mm. A plurality of heat bolts, for example, several tens of heat bolts are arranged preferably at a pitch of 20 to 40 mm. A gap adjusting member mainly made up of a bolt for adjusting the slit gap by manually movement in the axial direction can be provided, instead of a heat bolt. The slit gap adjusted by the gap adjusting member normally has a diameter of 200 to 1,000 μm, preferably 300 through 800 μm, more preferably 400 to 600 μm.

The first through third cooling rolls are made of a seamless steel pipe having a wall thickness of about 20 through 30 mm. The surface is mirror finished. It contains a tube for feeding a coolant. Heat is absorbed from the film on the roll by the coolant flowing through the tube. Of these first through third cooling rolls, the first cooling roll 5 corresponds to the rotary supporting member used in the present invention.

The touch roll 6 contact with the first cooling roll 5 has an elastic surface. It is deformed along the surface of the first cooling roll 5 by the pressure against the first cooling roll 5, and forms a nip between this roll and the first roll 5. To be more specific, the touch roll 6 corresponds to the pressure rotary member used in the present invention.

FIG. 4 is a schematic cross section of the touch roll 6 as an embodiment of the present invention (hereinafter referred to as “touch roll A”). As illustrated, the touch roll A is made up of an elastic roller 42 arranged inside the flexible metallic sleeve 41.

The metallic sleeve 41 is made of a stainless steel having a thickness of 0.3 mm and flexibility. If the metallic sleeve 41 is too thin, strength will be insufficient. If it is too thick, elasticity will be insufficient. Thus, the thickness of the metallic sleeve 41 is preferably 0.1 through 1.5 mm. The elastic roller 42 is a roll formed by installing a rubber 44 on the surface of the metallic inner sleeve 43 freely rotatable through a bearing. When the touch roll A is pressed against the first cooling roll 5, the elastic roller 42 presses the metallic sleeve 41 against the first cooling roll 5, and the metallic sleeve 41 and elastic roller 42 is deformed, conforming to the shape of the first cooling roll 5, whereby a nip is formed between this roll and the first cooling roll. The cooling water 45 is fed into the space formed inside the metallic sleeve 41 with the elastic roller 42.

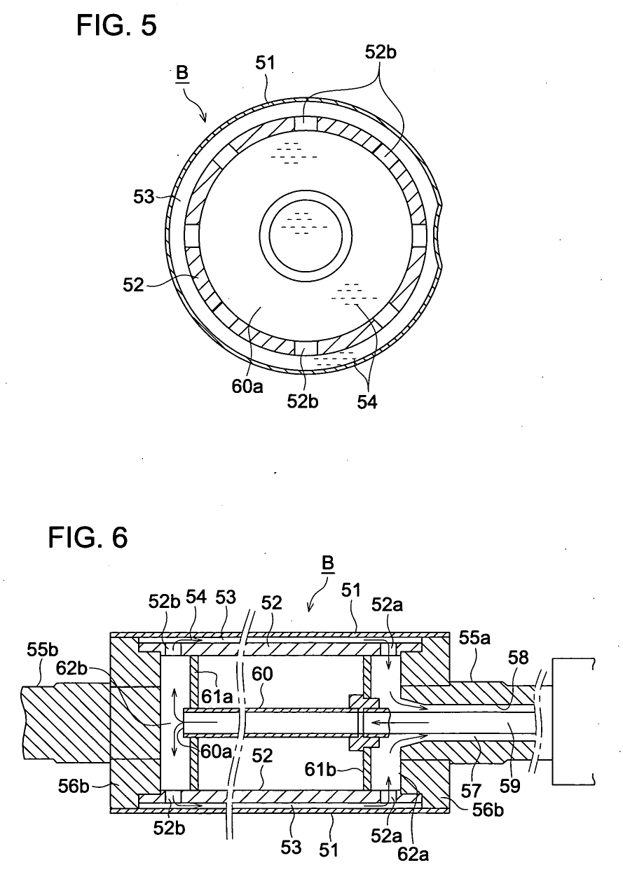

FIG. 5 and FIG. 6 show a touch roll B as another embodiment of the pressure rotary member. The touch roll B is formed of an outer sleeve 51 of flexible seamless stainless steel tube (having a thickness of 4 mm), and metallic inner sleeve 52 of high rigidity arranged coaxially inside this outer sleeve 51. Coolant 54 is led into the space 53 formed between the outer sleeve 51 and inner sleeve 52. To put it in greater details, the touch roll B is formed in such a way that the outer sleeve supporting flanges 56a and 56b are mounted on the rotary shafts 55a and 55b on both ends, and a thin-walled metallic outer sleeve 51 is mounted between the outer peripheral portions of these outer sleeve supporting flanges 56a and 56b. The fluid supply tube 59 is arranged coaxially inside the fluid outlet port 58 which is formed on the shaft center of the rotary shaft 55a and constitutes a fluid return passage 57. This fluid supply tube 59 is connected and fixed to the fluid shaft sleeve 60 arranged on the shaft center which is arranged inside the thin-walled metallic outer sleeve 51. Inner sleeve supporting flanges 61a and 61b are mounted on both ends of this fluid shaft sleeve 60, respectively. A metallic inner sleeve 52 having a wall thickness of about 15 to 20 mm is mounted in the range from the position between the outer peripheral portions of these inner sleeve supporting flanges 61a and 61b to the outer sleeve supporting flange 56b on the other end. A coolant flow space 53 of, for example, about 10 mm is formed between this metallic inner sleeve 52 and thin-walled metallic outer sleeve 51. An outlet 52a and an inlet 52b communicating between the flow space 53 and intermediate passages 62a and 62b outside the inner sleeve supporting flanges 61a and 61b are formed on the metallic inner sleeves 52 close to both ends, respectively.

To provide flexibility, pliability and restoring force close to those of the rubber, the outer sleeve 51 is designed thin within the range permitted by the thin cylinder theory of elastic mechanics. The pliability evaluated by the thin cylinder theory is expressed by wall thickness t/roll radium r. The smaller the t/r becomes, the higher the pliability is given. The pliability of this touch roll B meets the optimum condition when t/r≦0.03. Normally, the commonly used touch roll has a roll diameter R=200 through 500 mm (roll radius r=R/2), a roll effective width L=500 through 1,600 mm, and an oblong shape of r/L<1. As shown in FIG. 6, for example, when roll diameter R=300 mm and the roll effective width L=1,200 mm, the suitable range of wall thickness t is 150×0.03=4.5 mm or less. When pressure is applied to the molten sheet width of 1,300 mm at the average linear pressure of 98 N/cm, the wall thickness of the outer sleeve 51 is 3 mm. Then the corresponding spring constant becomes the same as that of the rubber roll of the same shape. The width k of the nip between the outer sleeve 51 and cooling roll in the direction of roll rotation is about 9 mm. This gives a value approximately close to the nip width of this rubber roll is about 12 mm, showing that pressure can be applied under the similar conditions. The amount of bend in the nip width k is about 0.05 through 0.1 mm.

Here, t/r≦0.03 is assumed. In the case of the general roll diameter R=200 through 500 mm, sufficient flexibility is obtained if 2 mm≦t≦5 mm in particular. Thickness can be easily reduced by machining. Thus, this is very practical range. If the wall thickness is 2 mm or less, high-precision machining cannot be achieved due to elastic deformation during the step of processing.

The equivalent value of this 2 mm≦t≦5 mm can be expressed by 0.008≦t/r≦0.05 for the general roll diameter. In practice, under the conditions of t/r≈0.03, wall thickness is preferably increased in proportion to the roll diameter. For example, selection is made within the range of t=2 through 3 mm for the roll diameter R=200; and t=4 through 5 mm for the roll diameter R=500.

These touch rolls A and B are energized toward the first cooling roll by the energizing section, not illustrated. The F/W (linear pressure) obtained by dividing the energizing force F of the energizing section by the width W of the film in the nip along the rotary shaft of the first cooling roll 5 is set at 9.8 through 147 N/cm. According to the present embodiment, a nip is formed between the touch rolls A and B, and the first cooling roll 5. Flatness should be corrected while the film passes through this nip. Thus, as compared with the cases where the touch roll is made of a rigid body, and no nip is formed between the touch roll and the first cooling roll, the film is sandwiched and pressed at a smaller linear pressure for a longer time. This arrangement ensures more reliable correction of flatness. To be more specific, if the linear pressure is smaller than 9.8 N/cm, the die line cannot be removed sufficiently. Conversely, if the linear pressure is greater than 147 N/cm, the film cannot easily pass through the nip. This will cause uneven thickness of the film.

The surfaces of the touch rolls A and B are made of metal. This provides smooth surfaces of the touch rolls A and B, as compared with the case where touch rolls have rubber surfaces. The elastic body 44 of the elastic roller 42 can be made of ethylene propylene rubber, neoprene rubber, silicone rubber or the like.

To ensure that the die line is removed sufficiently by the touch roll 6, it is important that the film viscosity should lie within the appropriate range when the film is sandwiched and pressed by the touch roll 6. Further, cellulose ester is known to be affected by temperature to viscosity comparatively high degree. Thus, to set the viscosity within an appropriate range when the cellulose ester film is sandwiched and pressed by the touch roll 6, it is important to set the film temperature within an appropriate range when the cellulose ester film is sandwiched and pressed by the touch roll 6. When the glass-transition temperature of the cellulose ester film is assumed as Tg, the temperature T of the film immediately before the film is sandwiched and pressed by the touch roll 6 is preferably set in such a way that Tg<T<Tg+110° C. can be met. If the film temperature T is lower than Tg, the viscosity of the film will be too high to correct the die line. Conversely, if the film temperature T is higher than Tg+110° C., uniform adhesion between the film surface and roll cannot be achieved, and the die line cannot be corrected. This temperature is preferably Tg+10° C.<T2<Tg+90° C., more preferably Tg+20° C.<T2<Tg+70° C. To set the film temperature within the appropriate range when the cellulose ester film is sandwiched and pressed by the touch roll 6, one has only to adjust the length L of the nip between the first cooling roll 5 and touch roll 6 along the rotating direction of the first cooling roll 5, from the position P1 wherein the melt pressed out of the flow casting die 4 comes in contact with the first cooling roll 5.

The material preferably used for the first roll 5 and second roll 6 is exemplified by carbon steel, stainless steel and resin in the present invention. The surface accuracy is preferably set at a higher level. In terms of surface roughness, it is preferably set to 0.3 S or less, more preferably 0.01 S or less.

The portion from the opening (lip) of the flow casting die 4 to the first roll 5 is reduced to 70 kPa or less in the present invention. This procedure has been found out to correct the die line effectively. Pressure reduction is preferably 50 through 70 kPa. There is no restriction to the method of ensuring that the pressure in the portion from the opening (lip) of the flow casting die 4 to the first roll 5 is kept at 70 kPa or less. One of the methods is to reduce the pressure by using a pressure-resistant member to cover the portion from the flow casting die 4 to the periphery of the roll. In this case, the vacuum suction machine is preferably heated by a heater or the like to ensure that a sublimate will be deposited on the vacuum suction machine. In the present invention, if the suction pressure is too small, the sublimate cannot be sucked effectively. Adequate suction pressure must be utilized to prevent this.

The film-like cellulose ester based resin in the molten state from the T-die 4 is conveyed in contact with the first roll (the first cooling roll) 5, second cooling roll 7, and third cooling roll 8 sequentially, and is cooled and solidified, whereby an unstretched cellulose ester based resin film 10 is produced in the present invention.

The unstretched film 10 cooled, solidified and separated from the third cooling roll 8 by the separation roll 9 is passed through a dancer roll (film tension adjusting roll) 11, and is led to the stretching machine 12, wherein the film 10 is stretched in the lateral direction (across the width) in the embodiment of the present invention shown in FIG. 1. This stretching operation orients the molecules in the film.

A known tender or the like can be preferably used to stretch the film across the width. Especially when the film is stretched across the width, the lamination with the polarized film can be preferably realized in the form of a roll. Stretching across the width ensures that the low axis of the cellulose ester film made up of a cellulose ester based resin film is found across the width.

The transmission axis of the polarized film also lies across the width normally. If the polarizing plate wherein the transmission axis of the polarized film and the retardation phase axis of the optical film will be parallel to each other is incorporated in the liquid crystal display apparatus, the display contrast of the liquid crystal display apparatus can be increased and an excellent angle of field is obtained.

The glass transition temperature Tg of the film constituting material can be controlled when the types of the materials constituting the film and the proportion of the constituent materials are made different. When the phase difference film is manufactured as a cellulose film, Tg is 120° C. or more, preferably 135° C. or more. The film temperature environment is changed in the image display mode by the temperature rise of the apparatus per se, for example, by the temperature rise caused by a light source in the liquid crystal display apparatus. In this case, if the Tg of the film is lower than the film working environment temperature, a big change will occur to the retardation value and film geometry resulting from the orientation status of the molecules fixed in the film by stretching. If the Tg of the film is too high, temperature is raised when the film constituting material is formed into a film. This will increase the amount of energy consumed for heating. Further, the material may be decomposed at the time of forming a film, and this may cause coloring. Thus, Tg is preferably kept at 250° C. or less.

The process of cooling and relaxation under known thermal setting conditions can be applied in the stretching process. Appropriate adjustment should be made to obtain the characteristics required for the intended optical film.

The aforementioned stretching process and thermal setting process are applied as appropriate on a selective basis to provide the phase film function for the purpose of improving the physical properties of the phase film and to increase the angle of field in the liquid crystal display apparatus. When such a stretching process and thermal setting process are included, the heating and pressing process should be performed prior to the stretching process and thermal setting process.

When a phase difference film is produced as a cellulose ester film, and the functions of the polarizing plate protective film are combined, control of the refractive index is essential. The refractive index control can be provided by the process of stretching. The process of stretching is preferred. The following describes the method for stretching:

In the phase difference film stretching process, required retardations Ro and Rt can be controlled by a stretching at a magnification of 1.0 through 2.0 times in one direction of the cellulose resin, and at a magnification of 1.01 through 2.5 times in the direction perpendicular to the inner surface of the film. Here Ro denotes in-plane retardation and Rt retardation along the thickness.

The retardations Ro and Rt are given by the formulas;

Ro=(nx−ny)×d Formula (I)

Rt=((nx+ny)/2−nz)×d Formula (II)

In the formulas nx is refractive index in the retarded phase axis direction, ny is refractive index in the advanced phase axis direction, nz is refractive index in the thickness direction, measured at 23° C. and 55% RH employing light with at a wavelength of 590 nm, and d is film thickness in nm.

Measurement of the refractive indices, thickness and retardations of the optical film can be made by means of an Abbe diffraction meter (4 T), a micrometer on a market and an automatic birefringence meter KOBRA-21ADH (marketed by Oji Scientific Instruments), respectively.

Stretching can be performed sequentially or simultaneously, for example, in the longitudinal direction of the film and in the direction perpendicular thereto in the same plane of the film, namely, across the width. In this case, if the stretching magnification at least in one direction is insufficient, sufficient phase difference cannot be obtained. If it is excessive, stretching difficulties may occur and the film may break.

When the material is stretched in the melt-casting direction, the nz value will be excessive if there is excessive shrinkage across the width. This can be improved by controlling the shrinkage of the film across the width or by stretching across the width. In the case of stretching across the width, distribution may occur to the refractive index across the width. This distribution may appear when a tenter method is utilized. Stretching of the film across the width causes shrinkage force to appear at the center of the film because the ends are fixed in position. This is considered to be what is called “bowing”. In this case, bowing can be controlled by stretching in the casting direction, and the distribution of the phase difference across the width can be reduced.

Stretching in the biaxial directions perpendicular to each other reduces the fluctuation in the thickness of the obtained film. Excessive fluctuation in the thickness of the phase difference film will cause irregularity in phase difference. When used for liquid crystal display, irregularity in coloring or the like will occur.

The fluctuation in the thickness of the cellulose ester film is preferably kept within the range of ±3%, preferably ±1%. To achieve the aforementioned object, it is effective to use the method of stretching in the biaxial directions perpendicular to each other. The magnification rate of stretching in the biaxial directions perpendicular to each other is preferably 1.0 through 2.0 times in the casting direction, and 1.01 through 2.5 times across the width. Stretching in the range of 1.01 through 1.5 times in the casting direction and in the range of 1.05 through 2.0 times across the width will be more preferred to get retardation values.

When the absorption axis of the polarizer is present in the longitudinal direction, matching of the transmission axis of the polarizer is found across the width. To get a longer polarizing plate, the phase difference film is preferably drawn so as to get a low axis across the width.

When using the cellulose ester to get positive birefringence with respect to stress, stretching across the width will provide the low axis of the phase difference film across the width because of the aforementioned arrangement.

In this case, to improve display quality, the low axis of the phase difference film is preferably located across the width. To get the target retardation value, it is necessary to meet the following condition:

(Stretching magnification across the width)>(stretching magnification in casting direction)

After stretching, the end of the film is trimmed off by a slitter 13 to a width predetermined for the product. Then both ends of the film are knurled (embossed) by a knurling apparatus made up of an emboss ring 14 and back roll 15, and the film is wound by a winder 16. This arrangement prevents sticking in the cellulose ester film F (master winding) or scratch. Knurling can be provided by heating and pressing a metallic ring having a pattern of projections and depressions on the lateral surface. The gripping portions of the clips on both ends of the film are normally deformed and cannot be used as a film product. They are therefore cut out and are recycled as a material.

The film is wound on the winding roll while the shortest distance between the outer peripheral surface of the cylindrically wound film and the outer peripheral surface of the traveling type conveyance roll immediately before is kept at a minimum in the film winding process. Further, the front side of the winding roll is provided with a static elimination blower or the like that removes or reduces the potential on the film surface.

The winding machine to be used in the manufacture of a polarizing plate protective film of the present invention can be the one commonly employed. The film can be wound according to such a winding method as a constant tension method, constant torque method, taper tension method, and program tension control method of constant internal stress.

The initial winding tension at the time of winding the polarizing plate protective film is preferably 90.2 through 300.8 N/m in this case.

In the film winding process of the present invention, the film is wound preferably at a temperature of 20° C. through 30° C., with a relative humidity of 20% through 60% RH. When the temperature and humidity in the film winding process are controlled in this manner, the resistance of the retardation (Rt) along the length against the fluctuation in humidity can be improved.

If the temperature in the winding process is less than 20° C., wrinkles will occur and film winding quality is deteriorated so that the film cannot be put into practical use. This must be avoided. If the temperature in the film winding process has exceeded 30° C., wrinkles will also occur and film winding quality is deteriorated so that the film cannot be put into practical use.

If the humidity in the film winding process is less than 20% RH, electrostatic charge will occur easily and the film winding quality is deteriorated so that the film cannot be put into practical use. If the humidity in the film winding process has exceeded 60% RH, the winding quality, sticking trouble and conveyance property will be deteriorated.

When the polarizing plate protective film is wound in a roll, any core located on the cylinder can be used as a winding core. It is preferably a hollow plastic core. Any material can be used as a plastic material, if it is a heat resistant plastic material capable of resisting the temperature at the time of heating. It can be exemplified by phenol resin, xylene resin, melamine resin, polyester resin, and epoxy resin. The thermosetting resin reinforced by such a filler as a glass fiber is preferably used, and is exemplified by a hollow plastic winding ore of FRP having an outer diameter of 6 inches (hereinafter an inch is equivalent to 2.54 cm) and an inner diameter of 5 inches.

The number of turns on such a winding core is preferably 100 or more, more preferably 500. The winding width is preferably 5 cm or more. The width of the film substrate is preferably 80 cm or more, more preferably 1 m or more.

When the phase difference film is a polarizing plate protective film, the thickness of the protective film is preferably 10 to 500 μm. In particular, the lower limit is 20 μm, preferably 35 μm. The upper limit is 150 μm, preferably 120 μm. The particularly preferred range is 25 to 90 μm. If the phase difference film is too thick, the polarizing plate subsequent to machining will be too thick. This fails to meet low-profile light weight requirements when employed in the liquid crystal display for a notebook PC or mobile type electronic equipment. Conversely, if the phase difference film is too thin, retardation as a phase difference film cannot occur easily. Further, the film moisture permeability will be increased, with the result that the polarizer cannot be effectively protected from moisture. This must be avoided.

The retarded axis or advanced axis of the phase difference film is present in the same plane of the film. Assume that the angle formed with the direction of film formation is θ1. Then the θ1 should be −1° through +1°, preferably −0.5° through +0.5°.

This θ1 can be defined as an orientation angle. It can be measured by an automatic double refractometer KOBRA-21ADH (by Oji Scientific Instruments).

If θ1 meets the aforementioned formula, a high degree of brightness is ensured in the display image and a leakage of light is reduced or prevented, with the result that color representation with high fidelity is provided in the color liquid crystal display apparatus.

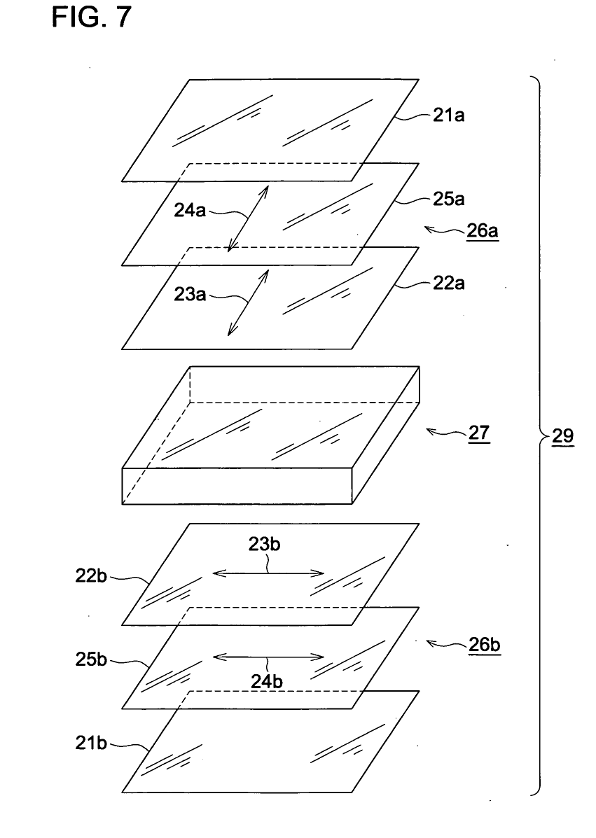

When the phase difference film is used in the multiple-domain VA mode, the phase difference film is arranged in the aforementioned range wherein the high axis of the phase difference film is θ1. This arrangement improves the display quality of the image. When a polarizing plate and a liquid crystal display apparatus are arranged as MVA mode it is composed as shown by FIG. 7

In FIG. 7, the reference numerals 21a and 21b indicate protective films, 22a and 22b represent phase difference films, 25a and 25b show polarizers, 23a and 23b indicate the low-axis directions of the film, 24a and 24b show the directions of the polarizer transmission axis, 26a and 26b denote polarizing plates, 27 shows a liquid crystal cell, and 29 denotes a liquid crystal display apparatus.

The distribution of the retardation Ro in the in-plane direction of the cellulose ester film is adjusted to preferably 5% or less, more preferably 2% or less, still more preferably 1.5% or less. Further, the distribution of retardation Rt along the thickness of the film is adjusted to preferably 10% or less, more preferably 2% or less, still more preferably 1.5% or less.

In the phase difference film, the fluctuation in the distribution of the retardation value is preferred to be as small as possible. When a polarizing plate containing the phase difference film is used in the liquid crystal display apparatus, a smaller fluctuation in the distribution of the aforementioned retardation distribution is preferred for the purpose of preventing color irregularity.

In order to adjust the phase difference film so as to provide the retardation value suited for improvement of the display quality of the liquid crystal cell in the VA mode or TN mode and to divide into the aforementioned multi-domain especially in the VA mode for preferable use in the MVA mode, adjustment must be made to ensure that the in-plane retardation Ro is greater than 30 nm without exceeding 95 nm, and retardation Rt along the thickness is greater than 70 nm without exceeding 400 nm.

The aforementioned in-plane retardation Ro has the following function. In the configuration shown in FIG. 7 wherein two polarizing plates are arranged in a crossed-Nicols configuration and a liquid crystal cell is arranged between the polarizing plates, assume a crossed-Nicols configuration with respect to the standard wherein observation is made from the direction normal to the display surface. When viewed obliquely from the line normal to the display surface, a deviation occurs from the crossed-Nicols arrangement of the polarizing plate, and causes the leakage of light. This leakage is mainly compensated. In the aforementioned TN mode and VA mode, particularly in the MVA mode, when the liquid crystal cell is set to the black-and-white display mode, the retardation along the thickness mainly compensates for the birefringence of the liquid crystal cell recognized when viewed obliquely in the same manner as above.

As shown in FIG. 7, when two polarizing plates are arranged on the upper and lower portions of the liquid crystal cell in the liquid crystal display apparatus, the reference numerals 22a and 22b in FIG. 7 are cable of selecting the distribution of retardation Rt along the thickness. It is preferred to ensure that the requirements of the aforementioned range are met, and the total of both retardations Rt along the thickness is preferably greater than 140 nm without exceeding 500 nm. In this case, the in-plane retardation Ro of the 22a and 22b and retardation Rt along the thickness retardation Rt are the same. This is preferred to improve the productivity of industrial polarizing plates. It is particularly preferred that the in-plane retardation Ro is greater than 35 nm without exceeding 65 nm, the retardation Rt along the thickness retardation Rt is greater than 90 nm without exceeding 180 nm, and the structure shown in FIG. 7 is applied to the liquid crystal cell in the MVA mode.

In the liquid crystal display apparatus, assume that the TAC film having an in-plane retardation Ro of 0 through 4 nm, a retardation Rt along the thickness of 20 through 50 nm and a thickness of 35 through 85 μm is used at the position 22b in FIG. 7 as one of the polarizing plates, for example, as a commercially available polarizing plate protective film.

In this case, the polarizing film arranged on the other polarizing plate, for example, the polarizing film arranged in 22a of FIG. 7 is preferred to have an in-plane retardation Ro of greater than 30 nm without exceeding 95 nm, and the retardation Rt along the thickness of greater than 140 nm without exceeding 400 nm. This arrangement improves the display quality and film productivity.

### <<Polarization Plate>>

When the cellulose ester film relating to the invention is used as a polarization plate protection film, the polarization plate can be produced by a usual method without any limitation. It is preferable that the cellulose ester film of the invention is saponified by alkaline treatment on the backside thereof and the treated film is pasted on at least one side of a polarization membrane, which is prepared by immersing and stretching in an iodine solution, using a completely saponified poly(vinyl alcohol).

On the other side of the membrane, the cellulose ester film or another polarization plate protection film may be either used. As the polarization plate protection film to be used on the side other than that on which the cellulose ester film of the invention is used, films available on the market can be used. For instance, KC8UX2M, KC4UX, KC5UX, KC4UY, KC8UY, KC12UR, KC8UCR-3, KC8UCR-4, KC4FR-1, KC8UY-HA and KC8UX-RHA, each manufactured by Konica Minolta Inc., are preferably usable as the cellulose ester film available on the market. Optical compensation film serving also as the polarization plate protection film which has an optical anisotropic layer formed by orientating a liquid crystal compound such as discotic liquid crystals, rod-shaped liquid crystals and cholesteric liquid crystals is also preferably used. For example, the optical anisotropic layer can be formed by the method described in JP A 2003-98348. A polarization plate having excellent flatness and stably viewing angle expanding effect can be obtained by combination use of such the optical compensation film with the cellulose ester film of the invention. Furthermore, a film other than the cellulose ester such a cyclic olefin resin, an acryl resin a polyester may be used as the polarization plate protection film on the other side of the polarization plate.

Treatments for easily pasting such as those described in JP A H06-94915 and JP A H06-118232 may be applied instead of the alkali treatment for producing the polarization plate.

The polarization membrane as the principal constitution element of the polarization plate is an element through which light polarized in a certain direction only can be passed. Present known typical polarization membrane is a poly(vinyl alcohol) type polarization film which includes a poly(vinyl alcohol) type film dyed by iodine and that dyed by a dichromatic dye. As the polarization membrane, one prepared by forming a film from an aqueous solution of poly(vinyl alcohol) and mono-axially stretching and dying the film or one prepared by mono-axially stretching after dying and then treating by a boron compound for giving durability are used. The thickness of the polarization membrane is from 5 to 40 μm, preferably from 5 to 30 μm, and particularly preferably from 5 to 20 μm. The one side of the cellulose ester film of the invention is pasted onto the surface of the polarization membrane to prepare the polarization plate. The pasting is preferably carried out by using an aqueous adhesive mainly composed of completely saponified poly(vinyl alcohol).

The polarization membrane is stretched in mono-axial direction (usually in the length direction). Consequently, the membrane is shrunk in the stretched direction (usually in the length direction) and elongated in the direction perpendicular to the stretched direction (usually in the width direction) when the film is placed under a high temperature and high humidity condition. The elongation and shrinking of the polarization plate is increased accompanied with decreasing of the thickness of the polarization plate protection film and the shrinking in the stretched direction of the polarization membrane is particularly remarkable. The stretching direction of the polarization membrane is usually pasted so as to agree the stretching direction thereof with the casting direction (MD direction) of the protection film. Therefore, it is important to inhibit the shrinkage in the casting direction when the thickness of the protection film is decreased. The cellulose ester film of the invention is suitable for such the polarization plate protection film since the film is excellent in the dimensional stability.

Wave-shaped ununiformity is not increased even after the aging test at 60° C. and 90% RH, and the viewing angle is not varied and high visibility can be provided after the aging test even when the polarization plate has the optical compensation film on the backside.

The polarization plate is constituted by the polarization membrane and the protection film for protecting the both surfaces of the membrane. The polarization plate can be constituted by pasting the protection film on one side and a separation film on the other side of the membrane. The protection film and the separation film are used for protecting the polarization plate in the course of forwarding and inspection process. In such the case, the separation film is pasted on the side of the polarization plate opposite to the side to be pasted to the liquid crystal plate for protecting the surface of the polarization plate. The separate film is used on the side of the polarization plate to be pasted to the liquid crystal plate to cover the adhesive layer for pasting polarization plate to the liquid crystal plate.

### <Liquid Crystal Display Apparatus>

The polarizing plate including the polarizing plate protective film of the present invention provides higher display quality than the normal polarizing plate. This is particularly suited for use in a multi-domain type liquid crystal display apparatus, more preferably to the multi-domain type liquid crystal display apparatus in the birefringence mode.

The polarizing plate of the present invention of the present invention can be used in the MVA (Multi-domain Vertical Alignment) mode, PVA (Patterned Vertical Alignment) mode, CPA (Continuous Pinwheel Alignment) mode, OCB (Optical Compensated Bend) mode, IPS (In Place Switching) mode and so on without being restricted to a specific liquid crystal mode or polarizing plate arrangement.

The liquid crystal display apparatus is coming into practical use as a colored and animation display apparatus. The display quality is improved by the present invention. The improved contrast and enhanced polarizing plate durability ensure faithful animation image display without easy fatigue on the part of the viewer.

In the liquid crystal display apparatus containing at least the polarizing plate incorporating a phase difference film, one polarizing plate containing the polarizing plate protective film as the optical film of the present invention is arranged on the liquid crystal cell, or two polarizing plates are arranged on both sides of the liquid crystal cell. In this case, the display quality is improved when means are provided to ensure that the side of the polarizing plate protective film of the present invention contained in the polarizing plate faces the liquid crystal cell of the liquid crystal display apparatus. Then the films 22a and 22b of FIG. 7 face the liquid crystal cell of the liquid crystal display apparatus.

In the aforementioned structure, the polarizing plate protective film of the present invention provides optical compensation of the liquid crystal cell. When the polarizing plate of the present invention is used in the liquid crystal display apparatus, at least one of the polarizing plates of the liquid crystal display apparatus should be used as a polarizing plate of the present invention. Use of the polarizing plate of the present invention improves the display quality and provides a liquid crystal display apparatus having excellent angle of field.

A polarizing plate protective film of cellulose derivative is used on the surface opposite the polarizing plate protective film of the present invention as viewed from the polarizer in the polarizing plate of the present invention. A general-purpose TAC film or the like can be employed. The polarizing plate protective film located far from the liquid crystal cell can be provided with another functional layer for the purpose of improving the quality of the display apparatus.

For example, in order to avoid reflection, glare, scratch and dust, and to improve brightness, it is possible to bond a film containing as a constituent a known functional layer as a display on the surface of the polarizing plate protective film of the present invention, without being restricted thereto.

Generally, to ensure stable optical characteristics, the phase difference film is required to exhibit small fluctuations in the Ro or Rt as the aforementioned retardation value. Especially, these fluctuations may cause irregularities of an image in the liquid crystal display apparatus in the birefringence mode.

The polarizing plate protective film manufactured in the present invention is mainly made of a cellulose resin. This arrangement makes it possible to use the process of alkaline treatment based on the saponification inherent to the cellulose ester. Similarly to the case of the conventional polarizing plate protective film, this can be bonded with the polarizing plate protective film, using an aqueous solution containing a completely saponified polyvinyl alcohol, when the resin constituting the polarizer is polyvinyl alcohol. Thus, the embodiment of the present invention is superior in that the conventional method for manufacturing the polarizing plate can be applied. It is especially advantageous in that a longer roll polarizing plate can be obtained.

The production advantage of the present invention is remarkable especially in the case of a longer roll in excess of 100 meters. Greater advantages are observed in the production of a polarizing plate when it is longer, for example, in the order of 1,500 m, 2,500 m and 5,000 m.

For example, in the production of a polarizing plate protective film, roll length is 10 m-5,000 m, preferably 50 m-4,500 m when the productivity and transportability are taken into account. The width of a polarizer in this case can be selected to suit the width of the polarizer or the width suitable for the production line. It is possible to produce a film having a width of 0.5 m or more without exceeding 4.0 m, preferably 0.6 m or more without exceeding 3.0 m, and to wind the film in the form of a roll, which can be used to process a polarizing plate. It is also possible to manufacture a film having a width twice or more as great as the intended width, and to wind it in the form of a roll, which is cut to get the roll of an intended width. This roll can be used to process the polarizing plate.

When manufacturing the polarizing plate protective film, a functional layer such as antistatic layer, hard coated layer, lubricant layer, adhesive layer, antiglare layer and barrier layer can be coated before and/or after stretching. In this case, various forms of surface treatment such as corona discharging, plasma processing, medical fluid treatment can be provided wherever required.

In the film making process, the gripping portions of the clips on both ends of the film having been cut can be recycled as the material of the same type or different type of films, after having been pulverized, or after having been palletized as required.

A cellulose ester film of lamination structure can be manufactured by co-extrusion of the compositions containing cellulose esters having different concentrations of additives such as the aforementioned plasticizer, ultraviolet absorber and matting agent. For example, a cellulose ester film made up of a skin layer, core layer and skin layer can be produced. For example, a large quantity of matting agent can be put into the skin layer or the matting agent can be put only into the skin layer. Larger amounts of plasticizer and ultraviolet absorber can be put into the core layer than the skin layer. They can be put only in the core layer. Further, the types of the plasticizer and ultraviolet absorber can be changed in response to the core layer or skin layer. For example, it is also possible to make such arrangements that the skin layer contains a plasticizer and/or ultraviolet absorber of lower volatility, and the core layer contains a plasticizer of excellent plasticity or an ultraviolet absorber of excellent ultraviolet absorbing performance. The glass transition temperatures between the skin layer and core layer can be different from each other. The glass transition temperature of the core layer is preferably lower than that of the skin layer. In this case, the glass transition temperatures of both the skin and core are measured, and the average value obtained by calculation from the volume fraction thereof is defined as the aforementioned glass transition temperature Tg so that it is handled in the same manner. Further, the viscosity of the melt including the cellulose ester at the time of melt-casting can be different according to the skin layer or core layer. The viscosity of the skin layer can be greater than that of the core layer. Alternatively, the viscosity of the core layer can be equal to or greater than that of the skin layer.

In the display apparatus film of the present invention, assume that the dimensional stability is based on the standard dimensions of the film which has been left to stand for 24 hours at a temperature of 23° C. with a relative humidity of 55% RH. On this assumption, the dimensional stability of the film for display apparatus of the present invention is such that the fluctuation of the dimension at 80° C. and 90% RH is within ±2.0% (excl.), preferably within ±1.0% (excl.), more preferably within ±0.5% (excl.).

When the display apparatus film of the present embodiment is used as a polarizing plate protective film as a phase difference film, if the phase difference film itself has a fluctuation in excess of the aforementioned range, the absolute value of the retardation as a polarizing plate and the orientation angle will deviate from the initial setting. This may cause reduction in the capacity of improving the display quality, or may result in deterioration of the display quality.

### EXAMPLE

The present invention is demonstrated concretely in terms of examples, to which this invention is not restricted.

### Example 1

### Preparation of an Optical Film Having Cellulose Ester (Abbreviated as Cellulose Ester Film Hereafter) 1

Cellulose ester film 1 was prepared by means of melt casting method employing cellulose ester and various additives.

| | | |
|---|---|---|
| Cellulose ester C-1 | 100 | weight parts |
| TMPTB (described later) | 10 | weight parts |
| IRGANOX 1010 (marketed by Ciba Specialty | 0.5 | weight parts |
| Chemicals Corp.) | | |
| Tetrakis(2,4-di-tert-butyl-5-methylphenyl)[1,1- | 0.25 | weight parts |
| biphenyl]-4,4′-diylbisphosphonite | | |
| Exemplified high molecular compound A | 0.9 | weight parts |
| Tinuvin 928 (marketed by Ciba Specialty | 1.8 | weight parts |
| Chemicals Corp.) | | |

Cellulose ester, after having been dried at 70° C. under reduced pressure for 3 hours and cooled to room temperature, was mixed with the additives.

The above mixture was melting mixed to make pellets at 230° C. by use of a biaxial extruder. Herein, the glass transition temperature Tg of this pellet was 136° C.

These pellets were melted at 250° C. and extruded from casting die 4 onto first cooling roll 5 under a nitrogen atmosphere, and film was molded by sandwiching with pressure between first cooling roll 5 and touch roll 6. Further, silica particles AEROSIL 200V (marketed by Nippon Aerosil Co.), as a lubricant, was added so as to make 0.5 weight parts from a hopper opening at the middle portion of extruder 1.

A heat bolt was adjusted so as to make the gap width of casting die 4 of 0.5 mm within 30 mm from the film edge portions in the width direction, and of 1 mm at the other portion. As a touch roll, touch roll A was utilized, and water of 80° C. was let flow as cooling water inside thereof.

The length L along the circumference surface of the first cooling roll 5 from position P1, where resin being extruded from casting die 4 contacts the first cooling roll 5, to position P2, that is the upstream edge by 5 revolutions of first cooling roll 5 from the nip of first cooling roll 5 and touch roll 6, was set to 20 mm. Thereafter, touch roll 6 is separated from first cooling roll 5, and measured was temperature T at the melting portion immediately before resin was put with pressure between first cooling roll 5 and touch roll 6. Temperature T at the melting portion immediately before resin was put with pressure between first cooling roll 5 and touch roll 6 was measured by a thermometer (HA-200E, produced by Anritsu Instruments Co., Ltd.) at the position of further upstream side by 1 mm from nip upstream edge P2. As a result of measurement in this example, temperature T was 141° C. The line pressure of touch roll 6 against first cooling roll was set to 14.7 N/cm. Further, the film was introduced into a tenter, was stretched at 160° C. by 1.3 times in the width direction and cooled to 30° C. while being relaxed by 3% in the width direction. Then the film was released from clips to cut off the clipped portion, being subjected to a knurling treatment of 10 mm wide and 5 μm high at the both film edge sides, and was wound up on a core at a winding tension of 220 N/m and a taper of 40%. The extrusion amount and pulling rate were adjusted to make the film thickness of 80 μm, and the finished film was slit to make a width of 1,430 mm to be wound. The winding core had an inside diameter of 152 mm, an outside diameter of 165 mm and a length of 1,550 mm. As a mother material of this core, utilized was pre-impregnation resin in which epoxy resin was sintered into glass fiber and carbon fiber. Electric conductive epoxy resin was coated on the surface of a core, and the surface was polished to make finish surface roughness Ra of 0.3 μm. Herein the roll length was 2,500 m. This film master roll sample of the present invention was designated as No. 1.

Further, Cellulose ester film samples 2 through 24 were prepared in a method similar to cellulose ester film sample No. 1 except that the kind of the cellulose ester, and the additive-exemplified high molecular compound A were changed as described in table 2. An amount of cellulose ester in each sample was the same as Cellulose ester C-1, an amount of the additive exemplified high molecular compound was the same as that of exemplified high molecular compound A as for cellulose ester film samples No. 2 through 15 and 24, changed to 0.3 weight parts as for cellulose ester film samples No. 16 through 23.
C-1: Cellulose acetate propionate (degree of substitution of the acetyl group: 1.4, degree of substitution of the propionyl group: 1.3, molecular weight Mn: 86,000, and Mw/Mn: 2.5)
C-2: Cellulose acetate propionate (degree of substitution of the acetyl group: 1.3, degree of substitution of the propionyl group: 1.2, molecular weight Mn: 66,000, and Mw/Mn: 3.0)
C-3: Cellulose acetate propionate (degree of substitution of the acetyl group: 1.7, degree of substitution of the propionyl group: 1.0, molecular weight Mn: 73,000, and Mw/Mn: 2.9)
C-4: Cellulose acetate propionate (degree of substitution of the acetyl group: 2.0, degree of substitution of the propionyl group: 0.7, molecular weight Mn: 91,000, and Mw/Mn: 2.4)

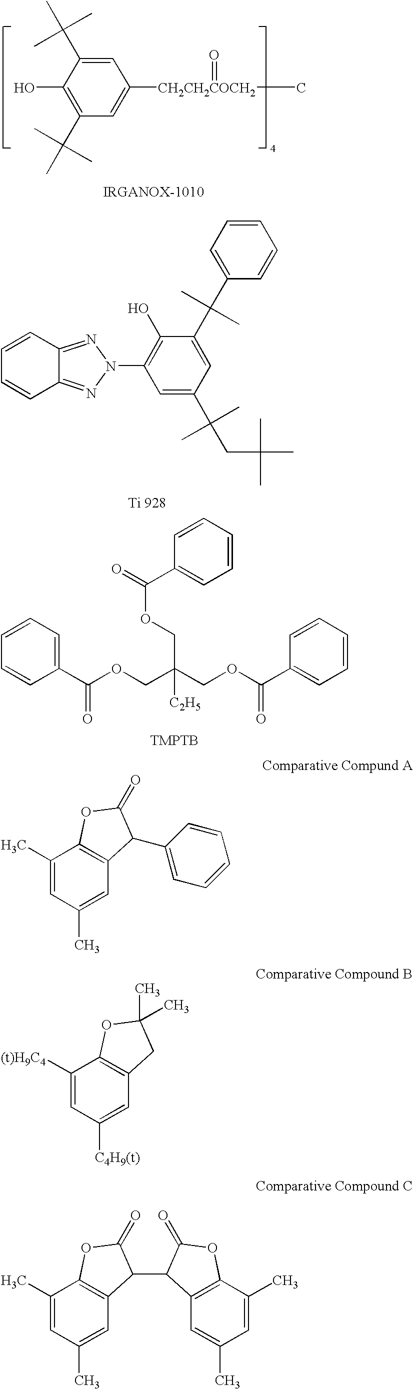

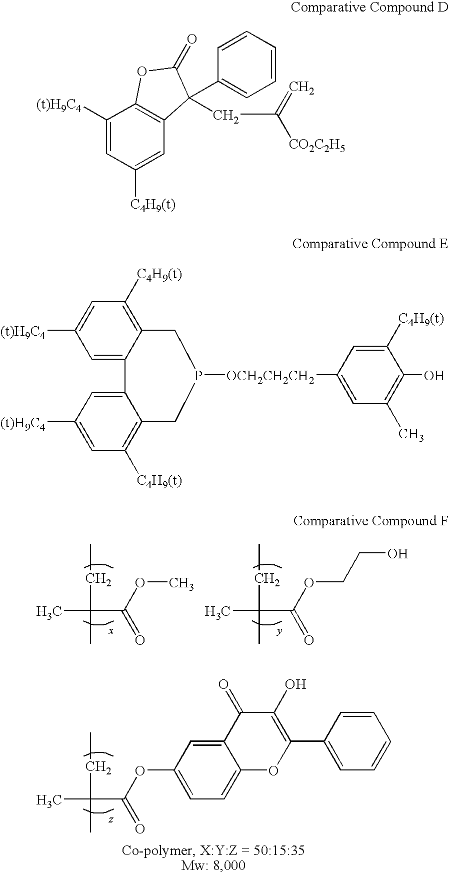

With respect to the prepared cellulose ester film master roll samples, evaluations were performed-according to the following methods. The result is shown in Table 2. Cellulose ester film was cut out from the each of master roll sample, and evaluation was conducted on bleed out and haze in the following method.

### (Horseback Defect, Core Set)

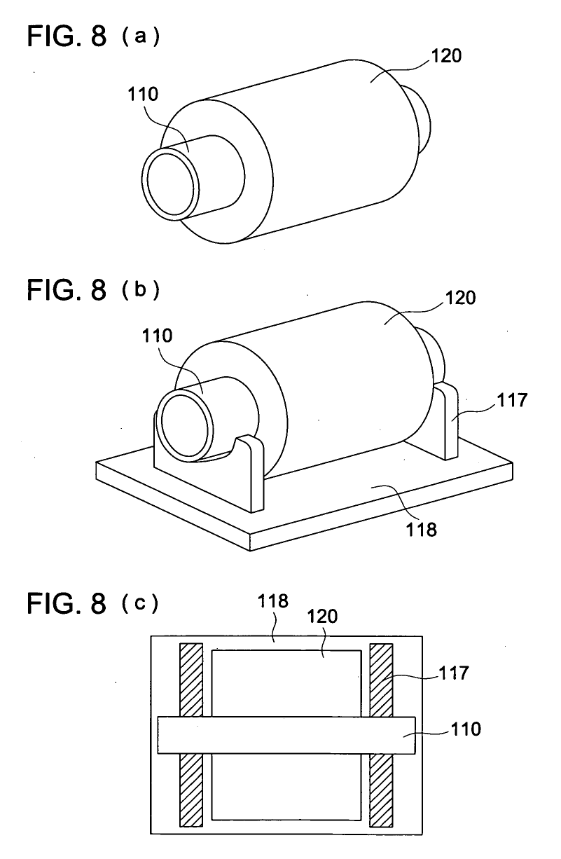

Wound wrinkle were doubly wrapped with a polyethylene sheet and stored for 30 days under a condition of 25° C., 50% by a storing method shown in FIGS. 8(a), 8(b) and 8(c). Thereafter, samples were taken out of the box, polyethylene sheet being opened, and distortion or fine irregularities were observed by reflecting a lit fluorescent tube on the surface of the film master roll sample, whereby the horseback defect was ranked based on the following criteria.

A: The fluorescent tube is observed to be straight.

B: The fluorescent tube is observed to be partly curved.

C: The fluorescent tube is observed to be reflected spotting.

Further, film master roll samples after having been stored were rewound, and till how many meters from the tail end generated was spot form deformation not smaller than 50 μm, or core set in which clearly observable band form deformation along the width direction, was measured, whereby core set was ranked according to the following criteria.

A: Less than 15 m from the tail end

B: Not less than 15 m to less than 30 m from the tail end

C: Not less than 30 m to less than 50 m from the tail end

D: Not less than 50 m from the tail end

### (Wrinkle at Start of Winding)

An operation to wind up master roll film on a core was performed, and the master roll film was detached from the core to restart the winding operation in the case that wrinkles were generated at the start of winding to cause a poor product. The times of this occasion were counted. This operation was repeated ten times to determine the average value. The ranking was performed based on the following criteria.

A: Not less than 0 and less than 1 time

B: Not less than 1 and less than 3 times

C: Not less than 3 and less than 5 times

D: Not less than 5 times

### (Bleed Out)

Cellulose ester film sample was allowed to stand for 1,000 hours under the condition of high temperature and high moisture of 80° C. and 90% RH, then bleed out (separated crystal) on the surface of the samples was visually observed. Evaluation was conducted with the following criteria.

A: Bleed out on the surface is not observed at all.

B: Bleed out on the part of surface is slightly observed.

C: Bleed out on the whole surface is slightly observed.

D: Bleed out on the whole surface is clearly observed.

### (Haze)

Haze measured by a haze meter (1001 DP, marketed by Nippon Denshoku Industries, Co, Ltd.) was converted to haze value having thickness of 80 μm, and was evaluated by the following criteria.

A: Less than 0.5% haze

B: Not less than 0.5% and less than 1.0% haze

C: Not less than 1.0% and less than 1.5% haze

D: Not less than 1.5% haze

TABLE 2

| Cellulose | | | Horse- | | | | | |
|---|---|---|---|---|---|---|---|---|
| ester film | Cellulose | | back | | Core | Bleed | | |
| No. | ester | Additive | Defect | Wrinkle | set | out | Haze | Remarks |
| 1 | C-1 | Exemplified Polymer A | A | A | A | A | A | Invention |
| 2 | C-1 | Exemplified Polymer B | A | A | A | A | A | Invention |
| 3 | C-1 | Exemplified Polymer C | A | A | A | A | A | Invention |
| 4 | C-1 | Exemplified Polymer D | A | A | A | A | A | Invention |
| 5 | C-1 | Exemplified Polymer E | A | A | A | A | A | Invention |
| 6 | C-1 | Exemplified Polymer F | A | A | A | A | A | Invention |
| 7 | C-1 | Exemplified Polymer G | A | A | A | B | A | Invention |
| 8 | C-1 | Exemplified Polymer H | A | A | A | A | A | Invention |
| 9 | C-1 | Exemplified Polymer I | A | A | A | B | A | Invention |
| 10 | C-1 | Exemplified Polymer J | A | A | B | A | B | Invention |
| 11 | C-1 | Exemplified Polymer K | A | A | A | A | A | Invention |
| 12 | C-1 | Exemplified Polymer L | A | A | A | A | A | Invention |
| 13 | C-2 | Exemplified Polymer A | A | A | A | A | A | Invention |
| 14 | C-3 | Exemplified Polymer A | A | A | A | A | A | Invention |
| 15 | C-4 | Exemplified Polymer A | A | A | A | A | A | Invention |
| 16 | C-1 | Exemplified Polymer N | A | B | B | A | B | Invention |
| 17 | C-1 | Exemplified Polymer S | A | B | B | B | B | Invention |
| 18 | C-1 | Exemplified Polymer V | A | B | B | B | B | Invention |
| 19 | C-1 | Comparative Compound A | C | D | D | D | D | Comparative |
| 20 | C-1 | Comparative Compound B | C | D | D | D | D | Comparative |
| 21 | C-1 | Comparative Compound C | C | D | D | D | D | Comparative |
| 22 | C-1 | Comparative Compound D | C | C | D | D | C | Comparative |
| 23 | C-1 | Comparative Compound E | C | D | D | D | D | Comparative |
| 24 | C-1 | Comparative Compound F | C | C | D | C | C | Comparative |

It is understood that the cellulose ester film master roll samples 1 through 18 containing the high molecular compounds derived from a compound represented by formula (1) according to the present invention are less drawbacks of horseback defect and core set when they are stored for long period and hard to generate deformation defect of the film master roll such as the wrinkle at start of winding in comparison with the cellulose ester film master roll comparative samples 19 through 24. It is also understood that UV ray absorbing property, bleed out and haze property is excellent in comparison with the comparative sample concerning with cellulose ester film cut out from the master roll sample.

### Example 2

The following compositions were prepared.

(Antistatic Layer Coating Composition (1))

| | |
|---|---|
| Polymethyl methacrylate (weight average molecular | 0.5 parts |
| weight of 550,000, Tg: 90° C.) | |
| Propylene glycol monomethylether | 60 parts |
| Methyl ethyl ketone | 16 parts |
| Methyl lactate | 5 parts |
| Methanol | 8 parts |
| Conductive polymer resin P-1 | 0.5 parts |
| (0.1-0.3 μm particles) | |

Conductive polymer resin P-1

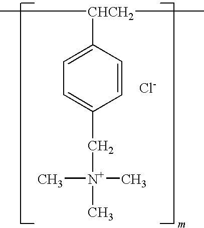

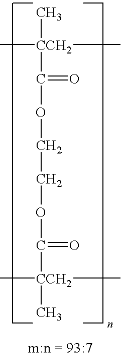

(Hard Coat Layer Coating Composition (2))

| | | |
|---|---|---|
| Dipentaerythritol hexaacrylate monomer | 60 | parts |
| Dipentaerythritol hexaacrylate dimer | 20 | parts |
| Component of dipentaerythritol hexaacrylate trimer or | 20 | parts |
| polymer | | |
| Diethoxybenzophenone photoreaction initiator | 6 | parts |
| Silicone type surfactant | 1 | part |
| Propylene glycol monomethylether | 75 | parts |
| Methyl ethyl ketone | 75 | parts |

(Anti-curl Layer Coating Composition (3))

| | | |
|---|---|---|
| Acetone | 35 | parts |
| Ethyl acetate | 45 | parts |
| Isopropyl alcohol | 5 | parts |
| Diacetyl cellulose | 0.5 | parts |
| 2% acetone dispersion of silica microparticles | 0.1 | part |
| (Aerosil 200V, marketed by Nippon Aerosil Co., | | |
| Ltd.) | | |

In the following manner, polarizing plate protective film provided with functions was prepared.

### (Polarizing Plate Protective Film)

Cellulose ester film master roll sample 1 prepared in Example 1 was doubly wrapped with a polyethylene sheet and stored for 30 days under a condition of 25° C. and 50%, then for 10 days under a condition of 40° C. and 80%, by a storing method shown in FIG. 8. Thereafter, each polyethylene sheet was removed and, on the one surface of cellulose ester film unwound from each master roll sample, anti-curl layer coating composition (3) was coated by means of gravure coating so as to make a wet layer thickness of 13 μm followed by being dried at 80±5° C. This sample was designated as sample 1A.

On the other side of this cellulose ester film, anti-static layer coating composition (1) was coated under an environment of 28° C. and 82% RH so as to make a wet layer thickness of 7 μm at a film conveying speed of 30 m/min and a coating width of 1 m, followed by being dried in a drying zone set at 80±5° C. to provide a resin layer having a dry layer thickness of 0.2 μm, whereby cellulose ester film provided with an anti-static layer was prepared. This was designated as sample 1B.

Further, on this anti-static layer, hard coat layer coating composition (2) was coated so as to make a wet layer thickness of 13 μm and dried at a drying temperature of 90° C., followed by being irradiated by ultraviolet rays to make irradiation of 150 mJ/m², whereby a clear hard coat layer having a dry layer thickness of 5 μm was provided. This was designated as sample 1C.

Any of prepared cellulose ester film samples 1A, 1B and 1C had no brushing defect and no generation of cracks after drying resulting in good coating behavior.

Coating in a similar manner was performed utilizing cellulose ester film master roll samples 2 through 18 in place of cellulose ester film master roll sample 1. As a result, it has been proved that any of the samples shows good coating behavior.

As a comparison, also with respect to cellulose ester film master roll sample 19, coating was carried out in a similar manner as described above.

Those coated with anti-curl layer coating composition (3) were designated as sample 19A; those further coated with antistatic layer coating-composition (1) were designated as sample 19B; and those further coated with hard coat layer coating composition (2) on this antistatic layer were designated as sample 19C.

As a result, when coating was performed in a high humidity environment, sample 19A caused brushing. Further, with sample 19B micro cracks were sometimes recognized after drying, and with sample 19C micro cracks were clearly recognized after drying.

### (Preparation and Evaluation of Polarizing Plate)

Polyvinylalcohol film having a thickness of 120 μm was immersed in an aqueous solution containing 1 weight part of iodine, 2 weight parts of potassium iodide and 4 weight parts of boric acid and stretched at 50° C. by 4 times to prepare a polarizer.

Cellulose ester film master roll samples 1 through 18 and comparative cellulose ester film master roll sample 19, which were prepared in example 1 were doubly wrapped with a polyethylene sheet and stored for 30 days under a condition of 25° C. and 50%, then for 10 days under a condition of 40° C. and 80%, by a storing method shown in FIG. 8. Thereafter, each polyethylene sheet was removed and cellulose ester film unwound from each master roll samples was alkaline processed with a 2.5 mol/L sodium hydroxide aqueous solution at 40° C. for 60 seconds, further washed with water and dried, whereby the surface was provided with an alkaline treatment.

On the both surfaces of the above-described polarizer, the alkaline processed surfaces of samples of the present invention 1 through 18, and comparative sample 19 were pasted up by use of a 5% aqueous solution of completely saponificated type polyvinyl alcohol as an adhesive, whereby polarizing plates of the present invention 1 through 18, and comparative sample 19 were prepared.

The polarizing plates 1 through 18 display markedly excellent advantage having very good characteristics of the polarizing plates, since they are protected by protective film having excellent flatness and physical property on both sides in comparison with the comparative polarizing plate 19.

### (Characteristics Evaluation as Liquid Crystal Display)

The polarization plate of a 15-type TFT color liquid crystal display VL-1530S (produced by Fujitsu), was peeled and the above prepared polarization plates were each cut in a size meeting with the size of the liquid crystal cell.

Tow of the above prepared polarization plates were pasted on both sides of the liquid crystal cell so that the polarization axes of the polarization plates were crossed at right angle as the same as in the original apparatus to prepare a 15-type TFT color liquid crystal display, and then the display was subjected to evaluation as an image displaying apparatus. The Liquid crystal displays employing the polarization plates 1 through 18 according to the present invention showed excellent display characteristics with high contrast in comparison with that employing comparative polarizing plate 19. They were revealed to be excellent as the polarizing plate for the image display apparatus such as liquid crystal display apparatus.

1. (canceled)

2. The optical film of claim 8, wherein the polymerizable group is an unsubstituted ethylene series polymerizable group.

3. The optical film of claim 8, wherein the polymerizable group contains a group selected from the group consisting of an acryloyl group, a methacryloyl group and a styryl group.

4. The optical film of claim 8, which comprises cellulose ester.

5. A manufacturing method of the optical film of claim 8, wherein the optical film is manufactured by a melt-cast method.

6. A polarizing plate having the optical film of claim 8, at least on one surface of a polarizing element.

7. A liquid crystal display device using the polarizing plate of claim 6, at least one surface of a liquid crystal cell.

8. An optical film containing at least one of high molecular compound derived from a compound represented by Formula (1), 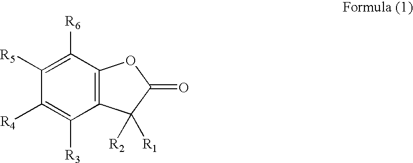
in the formula, R₁-R₆ are a hydrogen atom or a substituent, and R₁ and R₂ may be a substituent bonded via double bond together, provided that at least one of groups represented by R₁-R₆ is a group having a polymerizable group as a partial structure.

9. An optical film of claim 8, wherein the substituent is an alkyl group, a cycloalkyl group, an aryl group, an acylamino group, an alkylthio group, an arylthio group, an alkenyl group, a halogen atom, an alkynyl group, a heterocyclic group, an alkylsulfonyl group, an arylsulfonyl group, an alkylsulfinyl group, an arylsulfinyl group, a phosphono group, an acyl group, a carbamoyl group, a sulfamoyl group, a sulfonamide group, a cyano group, an alkoxy group, an aryloxy group, a heterocyclicoxy group, a siloxy group, an acyloxy group, a sulfonic acid group, a salt of sulfonic acid, an aminocarbonyloxy group, an amino group, an anilino group, an imido group, an ureido group, an alkoxycarbonylamino group, an alkoxycarbonyl group, an aryloxycarbonyl group, a heterocyclicthio group, a thioureido group, a carboxyl group, a salt of carboxylic acid, a hydroxyl group, a mercapto group or a nitro group.
